(19) United States
(12) Patent Application Publication
(10) Pub. No.: US 2023/0048111 A1
(43) Pub. Date: Feb. 16, 2023

(54) Apparatus for Applying Contact Resistance-Reducing Media and Applying Current to Plants

(71) Applicant: crop.zone GmbH, Aachen (DE)

(72) Inventors: Marcus Lehnen, Aachen (DE); Dirk Guido Vandenhirtz, Aachen (DE)

(21) Appl. No.: 17/788,726

(22) PCT Filed: Dec. 23, 2020
(86) PCT No.: PCT/EP2020/087773

§ 371 Date: Jun. 23, 2022

(30) Foreign Application Priority Data
Dec. 23, 2019 (DE) 102019135768.3
Jun. 17, 2020 (DE) 102020115923.4

(51) Int. Cl. A01M 21/04; A01G 7/04

(52) U.S. Cl. CPC A01M 21/046; A01G 7/04

(57) ABSTRACT

An apparatus for applying electrical current to plants is provided, comprising at least two synergistically acting modules, wherein a first module comprises at least one application device for applying a medium reducing the electrical contact resistance and a second module comprises at least one application device for applying electrical current to plants. The invention also relates to a method with which an increase in the effect of the application of electrical current to plants, e.g., to control plant growth, is achieved by reducing the electrical contact resistance.

### CROSS REFERENCE TO RELATED APPLICATION

This application is a U.S. National Stage entry under 35 U.S.C. § 371 based on International Application No. PCT/EP2020/087773, filed on Dec. 23, 2020, which was published under PCT Article 21(2) and which claims priority from German Application No. 102019135768.3, filed on Dec. 23, 2019 and from German Application No. 102020115923.4, filed on Jun. 17, 2020. The disclosure of each of the foregoing documents is incorporated herein by reference.

### TECHNICAL FIELD

The present invention relates to an apparatus for targeting transition resistance-reducing media and applying electric current to plants, and a method for controlling plant growth.

### BACKGROUND

In agriculture, urban areas, transportation sites and gardens, large amounts of systemic and non-systemic, selective and non-selective chemical herbicides are conventionally used for weed control, crop management and crop siccation. While the number of registered herbicides is generally decreasing, non-selective herbicides with very broad usage ranges and high usage rates, such as paraquat, glufosinate, diquat and glyphosate, in particular, are being severely restricted or completely banned worldwide. This challenges the profitability of individual cultures, the stability and safety of transportation facilities, and especially for maintaining soil and climate-friendly cultivation forms with low ground movement.

The herbicides that can still be used in the future must, in addition to being largely free of residues, in particular of the ingredients regulated under the Plant Protection Products Act of Germany, have the lowest possible acute and chronic toxicity, be able to be shifted to other environmental compartments as little as possible, have an ecological balance that is as environmentally friendly as possible, be compatible with regulations on organic cultivation if possible, and be able to be used efficiently in climate-friendly and ground-conserving crop cultivation. A number of substances that can be produced directly from natural products, or nature-identical substances, or mixtures of substances thereof, exhibit agriculturally acceptable herbicidal activity when used in sufficient quantities. However, the high price of pelargonic acid, for example, or the even higher cost of essential oils make it necessary to use these wax layer-destroying substances very sparingly and, accordingly, they often have an inadequate effect or are not used at all.

The mechanism of action of these above-designated chemical substances is ultimately more physical than metabolic, as these non-systemic contact herbicides primarily damage the plant surface and plant cells in such a manner that the plant excessively evaporates water and therefore dries out. Thus, the chemical substance can wet large parts of the plants, but the roots cannot be attacked directly. The substances also have an insufficient effect on thicker stems and leaves with very stable surface layers.

What all chemical treatments have in common is that, particularly if the roots are also to be killed, they require time for the substances to be distributed throughout the plant and take effect. This can take up to 3 weeks. At the same time, chemical residues mean that waiting periods of up to approximately 2 weeks must be observed with reseeding or plant emergence in order not to damage subsequent cultures. Purely physical methods are even less suitable in many cases, as they often only affect the shoot of the plant in a non-systemic manner and accordingly often have to be applied repeatedly and consume a lot of energy (e.g., laser, hot air, flaming, hot water) or, if they have a systemic effect in the soil, also lead to damage to the soil and climate (e.g., plowing, ground sterilization by heat).

However, literature and practice also show applications of herbicides when, as in the case of siccation, it is only intended to lead to faster drying of individual plant parts (e.g., potato weed, grass blades) without killing the entire plant. In addition, applications are also possible when the plants or associated other organisms are otherwise influenced by electric current (growth acceleration, insect deterrence, etc.).

It is also known from technical literature (LANDTECHNIK 72(4), 2017, 202-213, http://DOI:10.15150/lt.2017.3165) that plants can be massively damaged by the use of hot oil (up to 250° C.) sprayed directly onto the leaves with nozzles, since the heat transfer into the leaves occurs much better here than with water application (max. 100° C. and strong evaporative cooling). These act over a larger surface at close range than would be possible with hot water droplets. However, even with this non-systemic application, all plant parts to be damaged must come into direct contact with the hot oil drops. Accordingly, this is also clearly a non-systemic contact herbicide, which reaches its physical limits especially with thicker stems and high dense plant cover. The roots will not be damaged. The plants die only when a very large part of the shoots are damaged and they can not regenerate from roots.

Furthermore, it has been known for a long time that plants through which high voltage electrical current flows can be systemically damaged in their water supply system down to the roots. In many cases, seed plants can die completely and root weeds can be damaged at least enough to starve them out in the medium term. Since the use of this method, ways have been sought to keep the applied voltages or the energy usage as low as possible. However, hardly any systematic research has been conducted on this—as is usual for chemical crop protection agents—especially not with specific effect-enhancing formulations. Electrophysical methods have not yet been able to establish themselves as a standard method of plant control because, on the one hand, total chemical herbicides had become too cheap and, on the other hand, the social and global climatic pressure for environmentally and climate-friendly plant production within the framework of overall ground conservation management was still too low. Moreover, on the technical side, high voltages and relatively high energy consumption in the field have prevented the production of robustly working equipment with high impact power (working width×travel speed) and sufficient safety.

Traditionally, metallic applicators are used when applying current, at least to keep the electrical resistance at this point as low as possible. Furthermore, in some cases the electrical circuit is closed not by a second contacting of plants with the opposite pole, but by electrodes cutting into the ground to reduce the overall resistance. However, this halves the flow through plants (single instead of double) and thus significantly reduces efficiency.

The use of high voltages also requires wide clearances and barriers for work safety reasons (especially when metallic conductors may be present in the work area, such as in a vineyard or urban applications). The equipment is correspondingly expensive due to complex insulation and disadvantageously large due to increased clearance requirements for creepage distances. The technical and economic applicability of corresponding equipment is therefore low.

Conventional application of current to plants has been known to produce sparks between the applicator and plant parts, as well as deposits of an amorphous, poorly water-soluble and dark material on the applicators. It is assumed that plant hairs, unevenness and wax layers on the leaves lead to high transition resistance. The sparks generated at large potential differences between the applicators and plant parts vaporize parts of the wax layers, which are deposited on the applicators, causing additional resistance, thus requiring higher voltages and correspondingly costing more energy. No deposits occur with wet plants, since here apparently the lowered transition resistance prevents sparking, but also seems to greatly reduce the effect in general.

It is known from many years of development of crop protection agents that the leaves with their hydrophobic surface structures can only be wetted sufficiently and application-specific (plant type, plant size) with the help of complexly composed formulations. Especially for grasses, with their often hyperhydrophobic, highly waxy surfaces, the electrophysical method has so far had particular problems. These are further enhanced by very closely spaced culms mixed with dead culms (especially cordgrasses, rushes).

### SUMMARY

The task is to effectively apply current to different plants with the lowest possible transition resistance. This object is solved by a novel apparatus, a novel vehicle, and a novel method. The embodiments of the invention can be combined in an advantageous manner. A first aspect of the invention relates to an apparatus for applying electric current to plants, comprising at least two modules, a first module having at least one application device for applying a medium lowering an electrical transition resistance to plants, and a second module having at least one application device for applying electric current to plants.

The apparatus according to the invention advantageously allows the use of substances that do not have a metabolic-chemical effect, but only a physical-chemical effect on the leaves, in combination with an electrophysical treatment, e.g., in order to kill weeds or intercrops in one operation during a field crossing and to replant immediately or at very short notice. Costs and growth days, which are scarce in many regions of the world, are saved. Further, the effectiveness of weed control increases significantly because the fast-germinating crops have a much greater opportunity to win light competition with weeds through early emergence. This is particularly advantageous over ground movement weed control methods because no seeds are newly stimulated to germinate by light, etc., in the combination method described here.

Furthermore, the apparatus advantageously enables plants with hyperhydrophobic, highly waxy surfaces (e.g., grasses) and plants standing close together to be wetted and energized over a larger area by applying a medium that specifically lowers the electrical transition resistance (also called “electrohybrid medium”), especially liquids.

Application of the transition resistance-reducing medium lowers the transition resistance between the applicator and the main phase of the plant at multiple locations through all intermediate layers (e.g., air gap, spacing leaf hairs, wax layer, top cell layers) at one or more intermediate layers by bridging, softening, injury, or removal. This advantageously enables a systemic, plant damaging effect partially or down to the roots with low energy consumption. The invention thus also increases the energy efficiency of a current-applying method.

A transition resistance-reducing medium is a substance or mixture of substances whose properties actively facilitate the transfer of electrical current to a plant by reducing transition resistance through the applicator and leaf layers. The medium is therefore also referred to as an electrohybrid medium. The transition resistance-reducing medium is, for example, an aqueous liquid, a viscous liquid, e.g., oil, a highly concentrated solution, emulsion or suspension, a thixotropic liquid, a solid or a foam, without being limited to this enumeration. Furthermore, the advantageously reduced voltage increases occupational safety and fewer protective devices are required. Furthermore, the areas of increased stress potential in the ground are also reduced. This means that the only acute impact on ground organisms can be reduced even further, and cables with lower levels of protection against breakdown can continue to be used on and in the ground. Equipment with low energy consumption can also be significantly lighter, run on smaller tractors and therefore be used in row crops and particularly soil-friendly with low soil compression, or have larger working widths for the same output, requiring fewer field passes only in the standard travel lanes.

Advantageously, the apparatus according to the invention enables weakening or termination of undesired plant growth without specific loss of effect on resistant genotypes and without approval-relevant individual crop approvals. According to the invention, a transition resistance-reducing medium is applied by means of the application device to specific locations of plants to be controlled, where current is then applied to the plants by means of the application apparatus. In doing so, the invention allows flexible application of current for different weed sizes and types.

In contrast to the treatment of plants with conventional crop protection agents, which are distributed over the entire plant by wide-area application or by physiological distribution, the apparatus according to the invention enables local contacting with current into selected parts of the plant and then physical systemic transmission and action in the entire plant, wherein then also only the contact areas need to be wetted by the transition resistance-reducing medium. The application of the medium, which may be highly viscous, must be very controllable, selective on the surface and in the same direction as the applicator arrangement (e.g., from above or from the side). The effectiveness of the invention is also brought about by the fact that, compared to a conventional active ingredient, the current does not penetrate the leaves over the entire surface by diffusion, but rather at specific points where both the air gap between the applicator and the leaf and the wax layers or other barrier layers are bridged or destroyed by the medium. Accordingly, it is important for surface-altering effects to reach the sheet surface, but at the same time the layer thickness necessary for bridging must be maintained by viscosity, thixotropy or liquid cooling. Widening of the contact surface can then still be achieved by mechanical contact with the electrical applicator.

Preferably, the application device is connected to a heat source. This advantageously allows the transition resistance-reducing medium to be heated. For example, hot oil causes the wax layer to be destroyed before or during electrophysical treatment in the areas that come into contact with the electrical applicators. The necessary dosed spraying of small amounts of hot oil (0.5-20 l/ha, preferably 2-10 l/ha) only on the upper leaf areas greatly reduces the application rate compared to the known killing of the plants by large-scale application of hot oil, because the electrophysical treatment with low resistance of the contact surfaces then already has a systemic effect. The heat source can be, for example, an electric heating element, or advantageously the waste heat of a vehicle with the apparatus in the form of cooling water and exhaust gas, e.g., a tractor. Exhaust gas flows in diesel tractors are generally around 250-300° C. after all exhaust gas treatment systems. This is a similar temperature range to that just reached by readily biodegradable oils as the smoke point. The supply apparatus and the feed pipes of the application device advantageously function as a heat exchanger that transfers the heat to the medium.

Preferably, the application device is designed for dosing the transition resistance-reducing medium. In fact, if too much of it is applied, the current flows over it outside the plants ineffectively into the ground directly. Full or complete wetting of the plant is accordingly counterproductive. In this context, highly concentrated solutions can be advantageously applied by dosing. Appropriate application devices are particularly suitable and important for hot oils and concentrates, as these are only applied in small quantities. A commercially available example of such a designed low-water distribution apparatus for low-viscosity cold fluids are segmental rotary nozzles of MANKAR® ULV sprayers from Mantis ULV. Preferably, therefore, the application device of the apparatus according to the invention is designed as a nozzle (generally and not limited to rotary nozzles).

Preferably, the nozzle is designed as a sheath flow nozzle. When the plants are directly exposed to hot medium, this design advantageously enables spray losses of the transition resistance-reducing medium to be avoided, since the small droplet size and the airstream allow the droplets to drift off and cool down. In a sheath flow nozzle or analogous design, the droplet mist is tubular or preferably surrounded by two layers of hot gas flowing in the same direction and as laminar as possible. This gas stream may be at ambient temperature, but is preferably heated by the hot exhaust gas stream from a tractor as described above.

Preferably, the application device is arranged movably. This advantageously allows application of the transition resistance-reducing medium from different directions, e.g., from above or from the side.

Preferably, the application device is designed as a scraper. This makes the application device advantageously suitable for use in large surface applications at high speed and heterogeneous plant heights. The scrapers increase the accuracy of aiming when applying the medium and, accordingly, reduce the amount of the necessary medium on the leafs that can be reached by electric applicators. Furthermore, drift of the medium is counteracted and the complexity of the medium can be reduced. The medium can be transferred to the plants either by cold or heated scrapers with kinematics similar to electric applicators. The scrapers can be designed as an alternative to the nozzles. The application device can also be designed as both a scraper and a nozzle. These can then be arranged alternately, for example. A combination of nozzle and scraper in close spatial proximity is particularly advantageous, e.g., by arranging the nozzles on the scrapers. In this process, the medium can be sprayed over very short distances onto scrapers that have a very similar shape to the electric applicators. For example, to greatly increase the rate of action of the wax layer destruction, in one version of the apparatus, oil is heated before spraying and heat is transferred to the scraper. The scrapers are either made of a material with poor thermal conductivity or insulated on the side facing away from the plant.

By means of the heat source of the apparatus, the scrapers can be heated either exclusively or additionally (preferably with the exhaust gas stream of a tractor) in order to heat the wax layer and leaf surface of the leaves at all or additionally via their hot surface.

Preferably, in a further embodiment, the application device is connected to an additional high voltage source. This embodiment is particularly suitable for spray substances that are readily electrostatically chargeable. Plants in the direct vicinity of the electrophysical high-voltage treatment are electrostatically charged due to the ground potential. This observation advantageously allows also to charge the medium in such a manner that it settles and discharges on the nearest leaves, if possible.

The first module and the second module may be spatially very close to each other, allowing the application device to apply the transition resistance-reducing medium directly in front of or directly onto the electrical applicators of the application device. Thus, the transition resistance-reducing medium can be applied directly to the plants or indirectly to the plants via the application device.

In another preferred embodiment of the apparatus, the application device is arranged in such a manner that the transition resistance-reducing medium can be applied directly to the application device. In this embodiment, the transition resistance-reducing medium is applied indirectly to the plants via the application apparatus. This embodiment is particularly, but not exclusively, suitable for low spray dosages and very fast transition resistance-reducing media. In this case, current can be applied directly.

Preferably, the application apparatus is also connected to a heat source. The heat source can be the same as for the application device, i.e., electrical or based on the waste heat (exhaust gas, cooling water from engine/generator) of the corresponding vehicle. This embodiment is particularly advantageous for plants known for high resistance (e.g., thistles, milkweed, nettles). Cold to frost makes the use of purely chemical treatment methods virtually impossible in very many cases. At the same time, however, it is optimal, especially for the control of green manure, if it can be killed during ground frost. This generally allows the farmer to schedule more freely, accelerates equipment payback through multiple uses on larger surfaces, and reduces ground compression. Since the non-dead, hardy plants are still liquid and conductive inside the plant, due to general salts and special antifreeze agents (glycerol, etc.), it is only important to make any frost layers on the leaves and cold-induced hard wax layers appropriately vulnerable to attack by raising the temperature and increasing the reaction rates to destroy the wax layer.

Preferably, at least one sensor system is arranged in the area of the first and/or the second module, respectively, which comprises one or more sensors selected from the group consisting of optical sensors, lidar, height sensors, motion sensors, thermal sensors, current measurement sensors, and sensors designed to detect mechanical stresses. The use of sensors in patchy or highly heterogeneous growth advantageously allows for a growth-controlled application, wherein the application rate is controlled either by separate plant detection sensors (e.g., fluorescence sensors/cameras, multispectral/hyperspectral cameras) or by current flow and voltage measurements at the applicators or further voltage measurement device upstream of the transition resistance-reducing medium application device. Furthermore, the performance of the cameras can still be significantly improved but the use of AI techniques and the evaluation of three-dimensional reconstructed images based on single data or cumulated data of several sensor systems (camera, lidar, height sensors, etc.) operating in several frequency ranges (e.g., multispectral cameras or laser-based height measurement via chlorophyll fluorescence).

Particularly preferred are sensor systems that measure current flow, deflection angle, bending, etc. in the application apparatuses, also referred to as applicators, of the second module, or perform similar measurements in upstream applicator-like application apparatuses of the first module. According to the invention, low pulsed currents are passed through the application device and the respective current flow or resistance is measured and evaluated as a measure of plant growth. Temperature sensors can also be used to detect a cooling of heated applicators, used as a measure for passing plants and dosing the media accordingly.

RFID analog (radio-frequency identification) sensor systems are preferably used on the individual applicators for all sensors. They measure currents without contact and wirelessly, measure applicator temperatures, detect stresses due to bending, deflections, and position changes, and transmit them to a central measuring unit via an RFID-based radio system. Advantageously, this eliminates conventional problems caused by the necessary high-voltage insulation of sensor cables and sensor probes, which would have to be installed movably in the applicator area subject to high mechanical stress. The data collected by the sensors can also be used advantageously in the context of precision agriculture. This data can also be stored for use in precision agriculture.

Preferably, the application apparatus has a transition element with gradually or stepped increasing resistance at the end facing the plant. This can advantageously counteract the fact that when the plants are disconnected from the current flow, breakaway sparks occur which can ignite flammable material and possibly damage cables or other objects at the point of impact. For this reason, transition elements with increasing resistance are inserted at the ends of the metal sections. These elements are preferably porous and thus absorb moisture or have such good thermal conductivity that they can actively cool arcs by means of water vapor or cooling power.

Preferably, in the apparatus according to the invention, the application device is designed to perform its own movement in, against or transversely to the travel movement in addition to the travel movement. This embodiment advantageously allows minimizing shading effects that occur especially with very dense growing grass-like plants. This embodiment is particularly suitable for application devices which are in the form of a comb or brush, and further particularly when using a highly viscous medium or a foam. The application device can be height-selective and/or moved sideways, circularly or elliptically to improve effectiveness. Mechanical guides and corresponding drive elements can be provided for this purpose, for example. In addition to comb-type apparatus, brushes with an inclined axle (not perpendicular horizontal to the direction of travel) and units with kinematics similar to hay turners (e.g., star wheel rakes or belt rakes) are suitable for comprehensive combing of grasses to be treated.

In addition to co-rotating application apparatuses that rotate in the same direction to avoid shadowing effects, counter-rotating application apparatuses are particularly advantageous, especially brushes that are assigned to one or different poles to increase the efficiency of the current application.

Preferably, the second module has at least one metallic protective screen with lateral, edge-free electrical insulation. Similar, but only mechanically acting protective discs are known from hoeing technology, with which the crops are to be shielded from dust and flying soil in high-speed hoeing systems, and ideally at the same time the leaves of the crop are either lifted or pressed onto the ground in order to prevent the hoe from uprooting the entire plant in the event of a large overhang. Over the protective disc according to the invention, in which the metallic middle part is insulated on both sides up to a few millimeters (preferably 2-10) from the outer edge, weed leaves can no longer transfer tension to the protective disk and then further to the crop plant. The insulation is either firmly attached to the protective disk or runs as an additional smaller disk on the same axis. If the washers are not friction-locked, slightly larger insulating washers with a larger axle hole can also be used. This leads to the fact that also the front and rear edges of the metal disk are always covered and do not touch any plants electrically conductive. Alternatively, insulating protective surfaces on the front applicator edge or side or front and rear running insulating protective disks on the right and left of the metal disk with separate axis are possible.

The metallic cutting wheel is permanently and safely grounded. It either cuts the overtravelled leaf, thereby isolating it from the crop, or it pushes the leaf or stem into the ground so hard and sharply that the electrical termination with the ground and/or cutting wheel dissipates an electrical voltage directly into the ground rather than into the crop. This type of grounding is also suitable as a safety apparatus to specifically keep the high voltage inside the equipment and minimize effects on the area outside the processing surface. Depending on the substrate, it makes sense to prefer the cutting or pressing effect and, if necessary, to replace the metallic cutting edge with a broad-based disk or bead wheel and to maximize the surface conductivity by using an electrically highly conductive surface.

A second aspect of the invention relates to a vehicle having a apparatus according to the invention. The vehicle is advantageously a tractor or other field-mobile, optionally modular, vehicle to move and power the apparatus in agriculture. However, other vehicles and also rail vehicles are also suitable, which move the apparatus on the surfaces to be treated. This includes airborne and hand pushed vehicles. The vehicle advantageously serves as a carrier system, power source, drive source, and may be designed as a self-propelled vehicle or trailer.

A third aspect of the invention relates to a method of applying electric current to plants to exert a herbicidal effect by means of a apparatus according to the invention, comprising the steps of:
Targeted application of a transition resistance-reducing medium to plants, and
Applying electric current to plants wetted by the medium.

The advantages of the method correspond to the advantages of the apparatus according to the invention, as far as they are not limited to pure process features.

Advantageously, the transition resistance-reducing medium is selected from the group consisting of an aqueous liquid, an oily liquid, a viscous liquid, a highly viscous liquid, a highly concentrated solution, a thixotropic liquid, a suspension, an emulsion, a solid, a foam, and mixtures of said components. Viscous liquids, especially highly viscous liquids, as well as foams are particularly advantageous in counteracting the medium running down vertical plant structures, e.g., in minimizing shading effects.

Preferably, the amount of transition resistance-reducing medium applied is controlled as a function of the electrical conductivity of the plant and/or ground in the area of the application device and/or application apparatus. The amount is dosed in such a manner that the external, resistance-bearing plant organs (spines, leaf hairs, wax layers, cuticle) are chemically/physically weakened, bridged or destroyed where the electrophysical applicators touch the plant in order to exert the systemic effect on the entire plant.

Preferably, in the process according to the invention, the transition resistance-reducing medium, the application device and/or the application apparatus are heated to a maximum of the main boiling point of the transition resistance-reducing medium. Electrical apparatus or exhaust gas heat from the corresponding vehicle is used for this purpose. The heat transferred to plant leaves destroys wax structures or structures solidified and occupied with wax on the leaf surface. The melting wax structures intensify the destruction process and additionally increase the destabilization of the sheet structures, especially when oil or substances containing oil or fatty acid are used as transition resistance-reducing medium. At the same time, the oil film also reduces the evaporation of water immediately after the application of the oil and thus a rapid cooling of the leaf areas, which is advantageous for an electrical treatment of the leaves after an interval of seconds. The destabilized sheet structures without wax or other structures as insulators or spacers are then penetrable by the electrical applicators with 20-90% lower electrical resistance than non-treated leaf structures. As waxes are continuously cleaned from the electrical applicators by the addition of oil and the escape of water from the leaves with the help of the abrasive forces of the passing leaves, this further reduces contact resistances, which lowers the voltage and increases the current conducive to destruction. Additional heating also of the electric applicators is advantageous especially for large plants known for high resistance (e.g., thistles, melder, nettles).

Preferably, in the method according to the invention, the transition resistance-reducing medium is electrically charged. This takes advantage of the fact that plants in the immediate vicinity of the high-voltage electrophysical action, due to the ground potential, are electrostatically charged. The charged medium, e.g., in droplet form, settles on the nearest leaves if possible and is discharged. For this purpose, nozzles and the normally conductive spray bar as a whole are charged electrically in the opposite direction to the nearest current applicator on the plants, provided that direct current is used. In other words, the substance mixtures to be applied are electrically charged by applying high voltage to the spray modules so that they deposit more selectively on the oppositely charged parts of the plant. Charging is done by means of high voltage, as used in pasture fences. Care is taken to ensure that the maximum energy available in the event of accidental contact by humans remains low enough to avoid danger to humans.

Preferably, in the method according to the invention, the plants are additionally mechanically preconditioned and/or posttreated. Advantageously, the plants are additionally damaged directly before the treatment or after the electrophysical treatment, for example, by mowing, cutting, rolling, buckling, breaking, brushing, plucking. These measures act synergistically with the current application according to the invention to destroy plants.

The medium lowering the electrical transition resistance is described in more detail below.

The medium has at least one component that lowers the electrical transition resistance in the area of the plant surface. The component is preferably at least one first component containing at least one surface-active substance selected from the group consisting of surfactants, or at least one second component containing at least one viscosity-increasing substance selected from the group consisting of pure silicas, fumed silicas, mixed oxides, magnesium layer silicates, organic additives based on biogenic oils and their derivatives, polyamides and modified carbohydrates.

The at least one first component is preferably present in a mixture with the at least one second component. There are commercially available products that have such a mixture, such as the products Kantor (manufacturer agroplanta GmbH & Co. KG, Zustorf, Germany) and Hasten (manufacturer ADAMA Deutschland GmbH, Cologne, Germany).

The medium advantageously allows hydrophobic plant surface structures and insulating air gaps to be overcome, thereby increasing electrical conductivity between an electrical applicator and a plant and thereby allowing electrical current to be applied to the plant more effectively.

Due to its properties, the medium enables the transfer of electric current to a plant with significantly reduced resistance compared to the application of electric current to plants only by means of solid, usually metallic applicators.

The medium enables both a resistance-reduced overcoming of current flow disturbing structures of the applicators (unevenness, adhesions) and the plant, such as air layers (reinforced by hairs, leaf unevenness, spines), and also a more effective conducting of current in the conducted materials and layers, so that a systemic, plant-damaging effect occurs partially or up to the roots with low energy consumption. The medium thus increases the effectiveness of a current-applying method.

The medium is also called transition resistance-reducing medium. The medium is, for example, an aqueous liquid, a viscous liquid, a highly viscous liquid, an oil, a highly concentrated solution, a thixotropic liquid, a suspension, an emulsion, a solid, or a foam, without being limited to this enumeration.

The first component is also called component A. The surface-active substance from the group of surfactants advantageously comprises nonionic surfactants and ionic surfactants with high biodegradability. The surface-active substances act beneficially when wetting a plant surface. While almost all surfactants can be used, classes of substances and products with high biodegradability and ecological agricultural compatibility are preferred: Nature-identical or nature-similar biosurfactants, preferably industrially available non-ionic sugar surfactants such as alkylpolyglucosides (APGs), sucrose esters, other sugar esters, methyl glycoside esters, ethyl glycoside esters, N-methylglucamides or sorbitan esters (e.g., from Solverde), amphoteric surfactants such as cocoamidopropyl betaine (CAPB) or anionic surfactants (e.g., sodium lauryl sulfate from Solverde).

Further exemplary compounds of component A are given below. Enumerations, including those of the other components, are not exhaustive, but are also representative of compounds with an analogous effect in the sense of the invention, in this case the surface-active effect:
Non-ionic sugar surfactants:
Alkylpolyglucosid (APGs): The alkyl radicals have 4 to 40 carbon atoms of all possible isomers, preferably consisting of linear chains with major proportions of 8 to 14 carbon atoms as found, for example, in fatty acid alcohols produced from palm oil. The glucosides are isomers and anomers with 1-15 sugar units, preferably glucose with a degree of polymerization between 1 and 5 units or other sugar esters such as sucrose (sucrose esters), sorbitans (sorbitan esters).
Glycosidester: Esters with alcohols C1-C14 all isomers, also unsaturated and additionally functionalized with carboxylic acid, aldehyde groups and alcohol groups, preferably methyl and ethyl glycoside esters.
N-methylglucamides with carbon chains C1-C30 all isomers, also unsaturated and additionally functionalized with carboxylic acid, aldehyde groups and alcohol groups, preferably linear alkyl chains C2-C15.
Amphotere surfactants:
Cocoamidopropyl betaine (CAPB) with carbon chains C1-C30 all isomers, also unsaturated and additionally functionalized with carboxylic acid, aldehyde groups and alcohol groups, preferably linear alkyl chains C2-C15.
Anionic surfactants:

Sodium lauryl sulfate is used as an example of an anionic surfactant. However, mixtures with various alkyl radicals (C4-C20) of LAS (linear alkylbenzene sulfonates) but also of SAS (secondary alkane sulfonates), FAS (fatty alcohol sulfates) and soaps can be used.

The second component is also called component B. The viscosity-increasing substance is preferably a thixotropic substance or a substance mixture of the organic or inorganic rheological additives. The substances of component B advantageously exhibit high biocompatibility or degradability, such that they are compatible with organic agriculture. The substances or compounds mentioned are, for example: pure or fumed silicas, e.g., Sipernat or Aerosil from Evonik; mixed oxides, e.g., magnesium aluminum silicates such as Attapulgit (®Attagel from BASF Formulation Additives); magnesium layered silicates, e.g., Bentonite or Hectorite (e.g., Optigel or Garamite from BYK); organic additives based on biogenic oils such as castor oil or soybean oil. e.g., castor oil or soybean oil: e.g., Polythix from FINMA; from the synthetic area polyamides, e.g., polyacrylamides, e.g., Disparlon from King Industries; starch; modified celluloses, e.g., methyl cellulose, gum arabic, carmellose sodium, caragen, carbomer, hydroxy(m)ethyl cellulose, polyanionic cellulose, saccharides, tragacanth, pregelatinized starch or xanthan gum.

The biogenic oil is preferably selected from the group consisting of canola oil, sunflower oil, coconut oil, castor oil and soybean oil.

The derivatives of the oils can be, for example, their salts or esters.

The viscosity-increasing substance is preferably also the component lowering the electrical transition resistance in the area of the plant surface.

Preferably, in addition to component A and/or component B, the medium has at least one further component having at least one conductivity-increasing substance selected from the group consisting of inorganic salts, carbon, humic substances, chelated iron, other chelated metal ions and further metal ions with complexing agents. This component is also referred to as component C. The substances and/or substance mixtures of component C in question are, by way of example: inorganic salts: Magnesium sulfate, Na/K2SO4; carbon: amorphous or graphitic modifications such as graphite suspensions from CP Graphite Products, graphene or tubular carbon modifications, preferably also ground biochar such as plant charcoal500+ from Egos; counterions to the salts used in the components of the mixture of substances according to the invention: e.g., Na+, K+, Mg; Huminstoffe: e.g., Liqhumus von Humintech; chelatisiertes Eis; humic substances: e.g., Liqhumus from Humintech; chelated iron: e.g., Humiron from Humintech; metal ions chelated with GLDA (tetrasodium-N, N-bis(carboxylatomethyl)-L-glutamate, e.g., from Solverde) or other biodegradable compounds, preferably iron. The metal ions can also be complexed by other complexing agents from the group of polydentate complexing agents. Other divalent or trivalent metal ions can be used instead of iron.

With regard to the question of conductivity-increasing substances, it should be noted that only inorganic salts and inorganic counterions of organic substances are involved in the classical increase of the conductivity of a solution. Particularly in the case of the carbon derivatives and also the higher molecular weight humic substances, the conductivity of the leaf surfaces is increased even in the case of solid mixtures of substances, e.g., in the dried state of a transition resistance-reducing medium. Such drying processes occur very quickly when, for example, transition resistance-reducing media with low water dilution are applied, especially on hot days, or when the liquid films are distributed over a larger surface area across the sheet surface by the applicators. Therefore, specific conductivity increase is particularly advantageous in the sense of the invention.

Preferably, in addition to component A and/or component B, the medium has at least one further component which is at least one hygroscopic or evaporation-reducing substance selected from the group consisting of oils, microgels and polyalcohols. This component is also referred to as component D. The substances and/or substance mixtures of component D in question are, by way of example: Oils: Canola oil, sunflower oil, olive oil (hot-pressed fractions to increase stability, if necessary), also finished canola oil products such as Micula from Evergreen Garden Care; microgels: Acrylic acid gels (superabsorbents); polyalcohols: Glycerin.

Preferably, in addition to component A and/or component B, the medium has at least one further component containing at least one wax-softening substance selected from the group consisting of oils, esters, alcohols, polypeptides and alkoxylated triglycerides. This component is also referred to as component E. The substances and/or substance mixtures of component E in question are, by way of example: Oils: Canola oil, sunflower oil, olive oil (hot-pressed fractions to increase stability, if necessary), also finished canola oil products such as Micula from Evergreen Garden Care; esters: Fatty acid esters (esters with C1-C10 alcohols of all isomers, also unsaturated and additionally functionalized with carboxylic acid, aldehyde groups and alcohol groups), also finished products such as HASTEN (Vicchem company), a rapeseed oil ethyl ester; alkoxylated triglycerides: also as finished product KANTOR from Agroplanta.

Preferably, in addition to component A and/or component B, the medium has at least one further component containing at least one physical phytotoxic substance and/or wax layer dissolving substance selected from the group consisting of carboxylic acids, terpenes, aromatic oils, alkalis, functionalized polypeptides, inorganic alkalis and organic alkalis. This component is also referred to as component F. Physical-phytotoxic substances are understood here as substances that unspecifically or specifically destroy the wax layer of a plant, as well as substances that have other phytotoxic effects. The substances and/or substance mixtures of component F in question are, by way of example: Carboxylic acids: Pelargonic acid (C9) (e.g., pelargonic acid in Finalsan from Neudorff) or other branched or unbranched carboxylic acids with shorter (<C9), equally long (═C9) or longer (>C9) linear or branched saturated or mono- or polyunsaturated carbon chains (e.g., caproic acid, caprylic acid and capric acid). These carbon chains can be additionally functionalized by further functional groups such as alcohols, aldehydes or carboxylic acid groups, either once or several times. Terpenes: oils containing terpenes; aromatic oils: Citronella oil (also finished products from Barrier/UK), eugenol e.g., from clove oil (also finished products such as Skythe/USA), pine oil (also finished products from Sustainableformulations), peppermint oils (e.g., Biox-M from Certis); alkalis: inorganic alkalis (e.g., NaOH, KOH) or organic alkalis (e.g., salts of fatty acids or humic acids e.g., Liqhumus from Humintech).

Component E can also be used to destroy the wax layer (i.e., as component F). To do this, component E must be sufficiently hot. Preferably, high-boiling organic substances with low water content or without water content are used. A hot oil is particularly preferred.

Preferably, in addition to component A and/or component B, the medium has at least one further adhesion-promoting component containing at least one adhesion-promoting substance and/or at least one adhesion-promoting substance. The adhesion-promoting substance is selected from the group of foaming agents consisting of surfactants, proteins and their derivatives. The adhesion-enhancing substance (by further increasing viscosity) is selected from the group consisting of organic rheological additives, inorganic rheological additives (preferably with high biological compatibility), pure silicas, fumed silicas, mixed oxides, magnesium layer silicates, organic additives based on biogenic oils and their derivatives, and polyamides. This component is also referred to as component G. The component G causes a limited movement or distribution of the substance mixture on a corresponding plant or several, densely standing plants.

The surfactants can be non-ionic or anionic surfactants, e.g., foam markers from Kramp or protein foaming agents from Dr. Sthamer. Of the further adhesion-improving substances and/or substance mixtures of component G, the following are exemplary: pure or pyrogenic silicas: Sipernat or Aerosil from Evonik; mixed oxides: Magnesium aluminosilicates, e.g., Attapulgite (®Attagel from BASF Formulation Additives); magnesium layered silicates; bentonites or hectorites (e.g., Optigel or Garamite from BYK); organic additives based on biogenic oils such as castor oil or soybean oil: Polythix from FINMA; polyamides: Disparlon from King Industries.

The biogenic oil is preferably selected from the group consisting of canola oil, sunflower oil, coconut oil, castor oil and soybean oil.

The derivatives of the oils can be, for example, their salts or esters.

Preferably, in addition to component A and/or component B, the medium has at least one further component containing at least one ionization-promoting substance selected from the group consisting of inorganic salts, carbon, humic substances, chelated iron and other chelated metal ions. This component is also referred to as component H. Of the further substances and/or substance mixtures of component H, the following are exemplary: inorganic salts: Na/K2SO4 or other, counterions to salts of organic acids (Na+, K+) used; carbon: amorphous or graphitic modifications such as graphite suspensions of CP graphite products, graphene or tubular carbon modifications, preferably also ground biochar such as plant carbon500+ from Egos; humic substances: Liqhumus from Humintech; chelated iron: Humiron from Humintech, metal ions chelated with GLDA (tetrasodium-N, N-bis(carboxylatomethyl)-L-glutamate, e.g., from Solverde) or other biodegradable compounds, preferably iron.

Preferably, in addition to component A and/or component B, the medium has at least one further component containing at least one carrier liquid selected from the group consisting of water, organic liquids, vegetable oils, esters of vegetable oils and fatty acid esters. This component is also referred to as component I. The carrier liquids are advantageously suitable for diluting the mixture of substances. Of the substances and/or mixtures of substances of component I, exemplary are: Organic liquids: Vegetable oils; esters of vegetable oils (esters with C1-C10 alcohols, all isomers, also unsaturated and additionally functionalized with carboxylic acid, aldehyde groups and alcohol groups) and fatty acid esters (esters of fatty acids with C4-C30, thereby all isomers, also unsaturated fatty acids with C1-C10 alcohols, thereby all isomers, also unsaturated and additionally functionalized with carboxylic acid, aldehyde groups and alcohol groups).

Preferably, the medium has, in addition to component A and/or component B, at least one further component containing at least one substance stabilizing the storability or a tank mixture. This component is also referred to as component J. The substances and/or substance mixtures of component J are, for example, emulsifiers such as poloxamer (BASF), medium-chain triglycerides and/or biocides, preferably substances with high biodegradability.

As can be seen from the components described, there are some substances that perform a multiple function, i.e., can be used under different components, and are therefore preferred. Particular mention should be made here of humic substances, vegetable oils and their esters (esters with C1-C25 alcohols of all isomers, also unsaturated and additionally functionalized with carboxylic acid, aldehyde groups and alcohol groups, preferably fatty alcohols from natural sources), and conductivity-increasing components.

Depending on the application goal, the medium is preferably composed of the following components (optional components are mentioned in parentheses, which can be added further preferentially depending on the application goal):

a) Application target wetting: Mixtures of A+B (+C/D/H/I/J);

b) Application target specific increase in the conductivity of the surface: Mixtures of A+B+C (+D/H/I/J);

c) Application target Softening of the wax layer: Mixtures of A+B+E (+C/D/H/I/J);

d) Application target Destruction of the wax layer: Mixtures of A+B+F (+C/D/H/I/J);

e) Application target Bridging of resistances: Mixtures of A+B+G (+C/D/H/I/J);

f) Component H is only used if the electrostatic charge of plants and medium can be used;

g) Other combinations of A+B with components C/D/E/F/G/H/I/J can be used to cause combination effects to increase effectiveness.

Advantageous for the destruction of the wax layer before or during the electrophysical treatment is the destruction with heated media in general and especially with hot oil (in component E) in the areas in contact with the electrical applicators. The necessary dosing of small amounts of hot oil (0.5-20 l/ha, preferably 2-10 l/ha) only on the upper leaf areas greatly reduces the application rate compared to the pure (known) killing of plants by hot oil, because the electrophysical treatment with low resistance then has a systemic effect.

Preferably, the medium has at least one further component in addition to component A and/or component B, wherein the further component has component C, component E and/or component F. Components C, E and F are particularly effective, both individually and in combination, in lowering electrical transition resistance in the area of the plant surface. The transition resistance is significantly reduced by the increase in conductivity in layers in the area of the plant surface (component C), by the softening (softening) of layers in the area of the plant surface (component E), and/or by the dissolution (destruction) of layers in the area of the plant surface (component F) compared to treatment without the medium.

As component C, the medium preferably has humic substances and/or chelated iron, wherein the chelated iron is preferably iron chelated by humic acids. As component F, the medium preferably has fatty acids, mixtures of fatty acids and/or alkalized humic substances, wherein the fatty acids are preferably in alkalized and/or chelated form.

Particularly preferably, the medium has at least one further component in addition to component A and/or component B, wherein the further component is component C and/or component E.

Preferably, the medium has at least one further component in addition to component A and/or component B, wherein the further component is component C, component D and/or component E.

Instead of component A and/or component B, the medium may preferably have at least two components selected from the group consisting of a component C, a component E, and a component F. As described above, component C contains at least one conductivity-increasing substance selected from the group consisting of inorganic salts, carbon, humic substances, chelated iron, other chelated metal ions and metal ions with complexing agents, component E contains at least one wax-softening substance selected from the group consisting of oils, esters, alcohols, polypeptides and alkoxylated triglycerides, and component F contains at least one physical-phytotoxic and/or wax-layer-dissolving substance selected from the group consisting of carboxylic acids, terpenes, aromatic oils, alkalis, functionalized polypeptides, inorganic alkalis and organic alkalis.

Particularly preferably, the medium has either component C and component E or component C and component F.

The medium may preferably have at least one further component, wherein the further component is selected from the group consisting of a component A, a component B, a component D, a component G, a component H, a component I, and a component J.

Preferred media for specific uses are described below. The component name refers to the components described above. Preferred substances from this group are then named in further columns. The total application volume is preferably 10-200 l/ha (water-based) or 30-200 l/ha (water-based) or 10-300 l/ha (water-based) or 5-30 l/ha (oil-based) depending on the crop height with the aim of reaching only the uppermost leaf level that can be reached by applicators. The application rate refers to full-surface treatment when spraying on closed plant covers. If more than one component is specified for a target, these components may be used alone or as a mixture until the total application rate is reached. If alternative ranges are necessary for the quantity specifications, they are described separately. The media carrier water or vegetable oil-based components are not listed in the table, as they are always used to supplement the application volume.

Table 1 summarizes water-based media. These are especially intended for use on dicotyledonous plants.

TABLE 1

| | | Application | | |
|---|---|---|---|---|
| | | rate to be | | |
| | | set in general | | |
| | | kg/ha | Application | Application |
| | | Substance | rate to be | rate to be |
| | | class | set preferably | set Especially |
| | | according | kg/ha | kg/ha |
| | | to list | preferred | preferred |
| Component | | Component | substance | substance |
| name | Function | name | classes | class |
| A | Surfactant | 0-4 | 0-2 APGs, sugar | 0.2-0.5 sugar |
| | | | esters, CAPB | esters, CAPB |
| B | Thickener | 0-5 | 0-3 silicas mixed | 0-2 silicas |
| | | | oxide silicates layered | mixed oxide |
| | | | silicates, mod. | silicates layered |
| | | | cellulose | silicates |
| C | Conductivity | 1-10 | 1-10 sulfates, humic | 1-10 humic |
| | enhancer | | substances, chelated | substances, |
| | | | iron (GLDA) | chelated iron, |
| | | | | chelated with |
| | | | | humic acids, |
| | | | | alkalized |
| D | Evaporation | 0.1-10 | 0.1-5 vegetable | 0.1-2 |
| | reducing | | oils/vegetable oil | Vegetable oils |
| | | | esters | |
| E | Wax layer | 0.1-40 | 0.2-20, oils, poly- | 0.5-10, oils, fatty |
| | softening | | peptides, fatty acid | acid esters, |
| | | | esters, carboxylic acid | carboxylic acids |
| F | Wax layer | 0-40 | 0-20 fatty acids, | 0-10, non-toxic |
| | destroyer | | (pelargonic acid only | carboxylic acids, |
| | | | in dosages 0-50% of | Iron-containing |
| | | | the amounts permitted | metal soaps, |
| | | | in PPPs for the | alkalized humic |
| | | | respective crop). | substances |
| | | | Terpene oils, alkalized | |
| | | | humic substances, | |
| | | | iron-containing metal | |
| | | | soaps | |

Table 2 summarizes oil-based media. These are mainly intended for use on dicotyledonous plants.

TABLE 2

| | | Application | | |
|---|---|---|---|---|
| | | rate to be | | |
| | | set in | | |
| | | general | Application | Application |
| | | kg/ha | rate to be | rate to be |
| | | Substance | set preferably | set Especially |
| | | class re | kg/ha | kg/ha |
| | | list | preferred | preferred |
| Component | | Component | substance | substance |
| name | Function | name | classes | class |
| A | Surfactant | 0-2 | 0-1 APGs, sugar | 0-0.2 sugar esters, |
| | | | esters, CAPB | CAPB |
| B | Thickener | 0-2 | 0-2 silicas mixed oxide | 0-1 silicas mixed |
| | | | silicates layered | oxide silicates |
| | | | silicates, mod. | layered silicates, |
| | | | cellulose | cellulose |
| C | Conductivity | 1-10 | 1-10 sulfates, humic | 1-10 humic |
| | enhancer | | substances, chelated | substances, |
| | | | iron (GLDA) | chelated iron, |
| | | | | chelated with |
| | | | | humic acids, |
| | | | | alkalized |
| D | Hygroscopic | 0.1-10 | 0.1-5 glycerin, | 0.1-2 |
| | substances | | microgels | Glycerin |
| E | Wax layer | 0.1-40 | 0.2-20, oils, | 0.5-10, oils, fatty |
| | softener | | polypeptides, fatty acid | acid esters, |
| | | | esters, carboxylic acid | carboxylic acids |
| F | Wax layer | 0-40 | 0-20 fatty acids, | 0-10, non-toxic |
| | destroyer | | (pelargonic acid only in | carboxylic acids, |
| | | | dosages 0-50% of the | Iron-containing |
| | | | amounts permitted in | metal soaps, |
| | | | PPPs for the respec- | alkalized humic |
| | | | tive crop). Terpene | substances |
| | | | oils, alkalized humic | |
| | | | substances, iron- | |
| | | | containing metal soaps | |

Table 3 summarizes media for droplet applications. These are mainly intended for use on grasses.

TABLE 3

| | | Application | | |
|---|---|---|---|---|
| | | rate to be | | |
| | | set in general | Application | Application |
| | | kg/ha | rate to be | rate to be |
| | | Substance | set preferably | set Especially |
| | | class re | kg/ha | kg/ha |
| | | list | preferred | preferred |
| Component | | Component | substance | substance |
| name | Function | name | classes | class |
| A | Surfactant | 0-3 | 0-2 APGs, sugar | 0.2-0.5 sugar |
| | | | esters, CAPB | esters, CAPB |
| B | Thickener | 0-10 | 0-5 silicas mixed oxide | 1-5 silicas mixed |
| | | | silicates layered | oxide silicates |
| | | | silicates, mod. | layered silicates, |
| | | | cellulose | mod. cellulose |
| C | Conductivity | 1-10 | 1-10 sulfates, humic | 1-10 humic |
| | enhancer | | substances, chelated | substances, |
| | | | iron (GLDA) | chelated iron, |
| | | | | chelated with |
| | | | | humic acids, |
| | | | | alkalized |
| D | Evaporation | 0.1-10 | 0.1-5 vegetable | 0.1-2 |
| | reducing | | oils/vegetable oil | Vegetable oils |
| | substances | | esters | |
| E | Wax layer | 0.1-40 | 0.2-20, oils, | 0.5-10, oils, fatty |
| | softener | | polypeptides, fatty acid | acid esters, |
| | | | esters, carboxylic acid | carboxylic acids |
| F | Wax layer | 0-40 | 0-20 fatty acids, | 0-10, non-toxic |
| | destroyer | | (pelargonic acid only in | carboxylic acids, |
| | | | dosages 0-50% of the | Iron-containing |
| | | | amounts permitted in | metal soaps, |
| | | | PPPs for the respec- | alkalized humic |
| | | | tive crop). Terpene | substances |
| | | | oils, alkalized humic | |
| | | | substances, iron- | |
| | | | containing metal soaps | |

Table 4 summarizes media for foam-based applications. These are mainly intended for use on grasses.

TABLE 4

| | | Application | | |
|---|---|---|---|---|
| | | rate to be | | |
| | | set in general | | |
| | | kg/ha | Application | Application |
| | | Substance | rate to be | rate to be |
| | | class | set preferably | set Especially |
| | | according | kg/ha | kg/ha |
| | | to list | preferred | preferred |
| Component | | Component | substance | substance |
| name | Function | name | classes | class |
| A | Surfactant | 0-4 | 0-2 APGs, sugar | 0.2-0.5 sugar |
| | | | esters, CAPB | esters, CAPB |
| B | Thickener | 0-2 | 0-2 silicas mixed | 0-2 silicas mixed |
| | | | oxide silicates | oxide silicates |
| | | | layered silicates, | layered silicates |
| | | | mod. cellulose | |
| C | Conductivity | 1-10 | 1-10 sulfates, | 1-10 humic |
| | enhancer | | humic substances, | substances, |
| | | | chelated iron | chelated iron, |
| | | | (GLDA) | chelated with |
| | | | | humic acids, |
| | | | | alkalized |
| D | Evaporation | 0.1-10 | 0.1-5 vegetable | 0.1-2 |
| | reducing | | oils/vegetable oil | Vegetable oils |
| | | | esters | Glycerin |
| | | | Glycerin, microgels | |
| E | Wax layer | 0.1-40 | 0.2-20, oils, | 0.5-10, oils, fatty |
| | softener | | polypeptides, fatty | acid esters, |
| | | | acid esters, | carboxylic acids |
| | | | carboxylic acid | |
| F | Wax layer | 0-40 | 0-20 fatty acids, | 0-10, non-toxic |
| | destroyer | | (pelargonic acid | carboxylic acids, |
| | | | only in dosages 0- | Iron-containing |
| | | | 50% of the | metal soaps, |
| | | | amounts permitted | alkalized humic |
| | | | in PPPs for the | substances |
| | | | respective crop). | |
| | | | Terpene oils, | |
| | | | alkalized humic | |
| | | | substances, iron- | |
| | | | containing metal | |
| | | | soaps | |
| G | Foam | 0-2 | 0-1 | 0-1 |
| | additives | | | |

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIGS. 1A and 1B show an embodiment of a carrier vehicle comprising an embodiment of an apparatus in accordance with the invention.

FIG. 2 shows a further embodiment of a carrier vehicle with an apparatus in accordance with the invention in a side view.

FIGS. 3A and 3B show possible arrangements of the apparatus according to the invention on the carrier vehicle.

FIGS. 4A and 4B show possible arrangements of the apparatus according to the invention on the carrier vehicle.

FIGS. 5A, 5B and 5C show possible arrangements of the apparatus according to the invention on the carrier vehicle.

FIGS. 6A, 6B, 6C and 6D shows comparative presentation of different methods for conventional and inventive weed control.

FIG. 7 shows a schematic cross-sectional view of an application device designed as a nozzle.

FIG. 8 shows a schematic representation of a carrier vehicle with an exhaust gas flow line.

FIGS. 9A, 9B, 9C and 9D show an embodiment of an application device of the apparatus according to the invention.

FIGS. 10A, 10B, 10C and 10D shows a further embodiment of an application device of the apparatus according to the invention.

FIGS. 11A, 11B, 11C and 11D show a further embodiment of an application device of the apparatus according to the invention.

FIGS. 12A, 12B, 12C, 12D and 12E show a further embodiment of an application device of the apparatus according to the invention.

FIGS. 13A, 13B, 13C and 13D show a further embodiment of an application device of the apparatus according to the invention.

FIGS. 14A, 14B, 14C, 14D and 14E show an embodiment of an application device of the apparatus according to the invention.

FIGS. 15A and 15B show a further embodiment of an application device of the apparatus according to the invention.

FIGS. 16A and 16B show a further embodiment of an application device of the apparatus according to the invention.

FIGS. 17A, 17B and 17C show an arrangement of an application device with a measuring circuit for controlling the dosing.

FIGS. 18A, 18B, 18C and 18D show embodiments of insulating protective disks of the device according to the invention.

FIGS. 19A and 19B show an experiment plan of a terrain portion for treating plants by the method according to the invention.

FIG. 20 shows an experimental field portion in which the method according to the invention is performed.

FIG. 21 shows the results of the treatment of grain by means of the method according to the invention.

FIGS. 22A and 22B show the experiment arrangement for the treatment of potatoes by means of the method according to the invention.

FIG. 23 shows the results of the treatment of potatoes by means of the method according to the invention.

FIG. 24 shows the results of the treatment of potatoes by the method according to the invention in combination with a chemical secondary treatment.

FIG. 25 shows the results of treatment of potatoes by the method according to the invention, wherein the treatment was performed twice.

FIG. 26 shows the results of the treatment of potatoes by the method according to the invention, wherein four different treatment patterns were tested.

FIG. 27 shows the experiment arrangement for the treatment of potatoes by means of the method according to the invention in combination with haulm topping.

FIG. 28 shows the results of the treatment of potatoes by the method according to the invention in comparison with haulm topping.

FIG. 29 shows the results of treatment of potatoes by the method according to the invention in comparison with haulm topping, wherein the treatment by the method according to the invention was performed twice.

FIG. 30 shows the results of treatment of potatoes by means of the method according to the invention in combination with haulm topping.

### DETAILED DESCRIPTION

Reference will now be made in detail to some embodiments of the invention, examples of which are illustrated in the accompanying drawings.

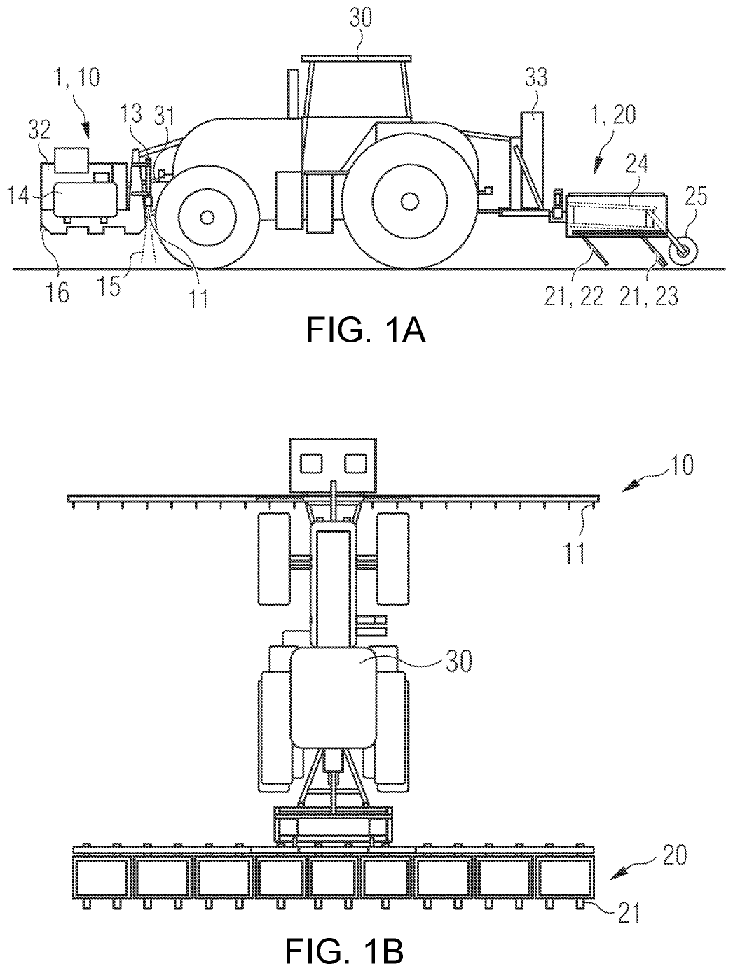

FIGS. 1A and 1B show an arrangement of the individual components of the apparatus 1 according to the invention on a tractor serving as a carrier vehicle 30. Alternatively, the tractor may be coupled to a trailer, for example, on which the apparatus 1 is arranged. The arrangement and carrier vehicle 30 may vary depending on the mode of operation and specific requirements of the crop and time of treatment in question.

The apparatus 1 has a first module 10 for applying a transition resistance-reducing medium 15 and a second module 20 for transmitting electric current to the plant parts. In this embodiment, the transition resistance-reducing medium 15 is a transition resistance-reducing liquid; hereinafter, the terms “transition resistance-reducing liquid” and “transition resistance-reducing medium” are used interchangeably.

The first module 10 is arranged at the front of the carrier vehicle 30. The second module 20 is arranged at the rear of the carrier vehicle 30. In accordance with the invention, this arrangement allows the application of the transition resistance-reducing medium 15 to always occur before or simultaneously with the electrophysical treatment.

The first module 10 has at least one application device designed as a nozzle 11. In combination with the nozzle 11, the application device can also comprise a wiper 12 (see FIGS. 8-14), or alternatively be designed as a scraper 12. The application device is thus designed for spraying and scraping the transition resistance-reducing liquid 15, or alternatively for spraying or scraping. The first module 10 thereby has a number of jointly or preferably individually controllable nozzles 11 or scrapers 12, which are arranged on a first support structure 13 in a desired working width of the apparatus 1 (e.g., 1.5-48 m, preferably 6-27 m) and geometry (statically or flexibly mounted or sensor-controlled in height). The nozzles 11 and/or scrapers 12 are supplied with transition resistance-reducing liquid 15 from one or more liquid containers 14. Sensors 16 are located in the area of the nozzles 11, among others (not shown), the data from which is used to control the amount of liquid as required. Additional sensors 16 may be located at the front of the first module 10 (i.e., in the direction of travel) for the purpose of occupational safety. Sensors used include, but are not limited to, current/voltage sensors, optical sensors 161 such as camera systems, position or movement sensors 162, LIDAR, metal detectors, and others. Drones flying ahead can also be used to detect plants ahead. Further, pasture fence applicators for deterring or startling animals may be disposed on the carrier vehicle 30 or the second module 20.

The tractor or similar carrier vehicle 30 preferably provides mechanical drive power via a PTO shaft 31 or hydraulic circuit to an electrical generator 32, which may be located in the front area (as shown) or rear area on the carrier vehicle 30. The individual modules of the apparatus 1 are arranged as attachments, for example, with three-point suspensions. Special crops require special machines, partly already as carrier vehicle with special suspensions, if necessary also laterally or under the carrier vehicle. In the case of equipment with very high power requirements due to, for example, very high working widths or carrier vehicles without sufficient free power capacity, independent power generator systems can also be used, which can be coupled onto the carrier vehicle, semi-mounted or moved on a trailer.

The electrical current is conducted from the generator 32 with cables to a transformation and control unit 33. There, the current is conditioned for transformation and then brought to the desired ultimately used frequency, waveform and voltage in centrally or distributedly positioned transformers and control units.

In the example shown, the second module 20 has a number of applicators 21 (FIG. 1B). The applicators 21 are arranged in a first applicator row 22 and a second applicator row 23 (FIG. 1A). The applicators 21 are arranged on a parallelogram-like second support structure 24, which can be height-positioned via a trailing auxiliary wheel (support wheel) 25 (depending on the crop, it can also be leading). In this arrangement, the current then flows into the plant via the first, forward applicators 22 in the direction of travel. The second, rear applicators 23 may rest or drag on the plant or penetrate the ground (not shown) through suitable devices (e.g., cutting wheel) to reduce drag, for example.

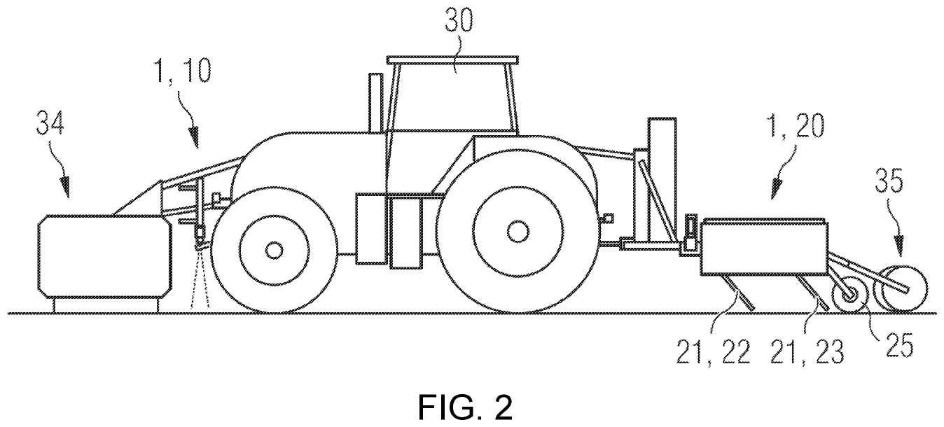

FIG. 2 shows a side view of a carrier vehicle 30 which has leading and trailing parts of the apparatus 1. A leading apparatus 34 is arranged in front of the first module 10 in the direction of travel. This is, for example, a mower or mulcher with which the plants are mowed or mulched to a height of 0.1-1.5 m, preferably 0.2-0.5 m, and then applied with transition resistance-reducing medium 15 by means of the first module 10 and subsequently treated with current by means of the second module 20. A trailing apparatus 35 is arranged behind the second module 20, in which further implements may be arranged, for example, for buckling thick plants, mulching, mowing, consolidating or sowing. The further implements may, for example, be fixedly connected to the carrier vehicle 30 or the second module 20, or may be attached thereto. The use of additional devices such as the leading and trailing devices 34, 35 is possible according to the invention, since, unlike almost all chemical methods, the destructive effect occurs immediately in the direct treatment period and does not require an effective time with standing plants.

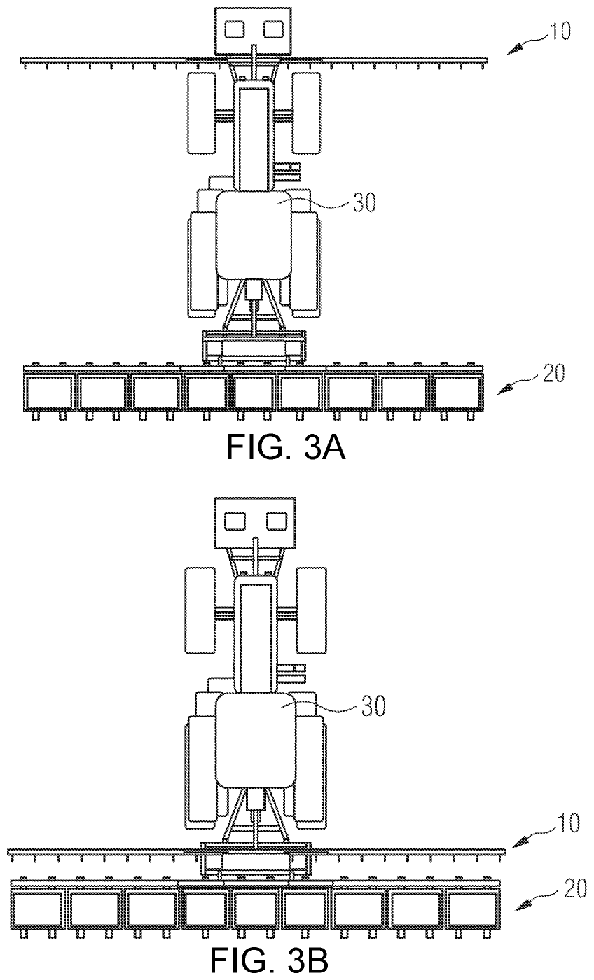

The embodiments of the apparatus 1 in accordance with FIGS. 3A and 3B allow plants to be treated within seconds (FIG. 3A) or fractions of a second (FIG. 3B). In FIG. 3A, the first module 10 is located at the front of the carrier vehicle 30. In this embodiment, after the transition resistance-reducing liquid 15 is applied, a few seconds elapse before the second module 20, located at the rear of the carrier vehicle 30, reaches the plants to be treated. In FIG. 3B, the first module 10 is located on the vehicle side of the second module 20 at the rear of the carrier vehicle 30. Here, only fractions of a second pass after application of the transition resistance-reducing liquid 15 before the second module 20 reaches the plants to be treated. The latter configuration may be preferred if the acceleration of action by suitable substances, hot media or heated applicators is sufficient for resistance reduction.

The working widths of the apparatus 1, i.e., the respective working widths of the first module 10 and the second module 20, are generally from 1.5 to 48 m. Only in rare cases do they exceed 48 m. Preferably, the working widths are in an area of 6 to 27 m.

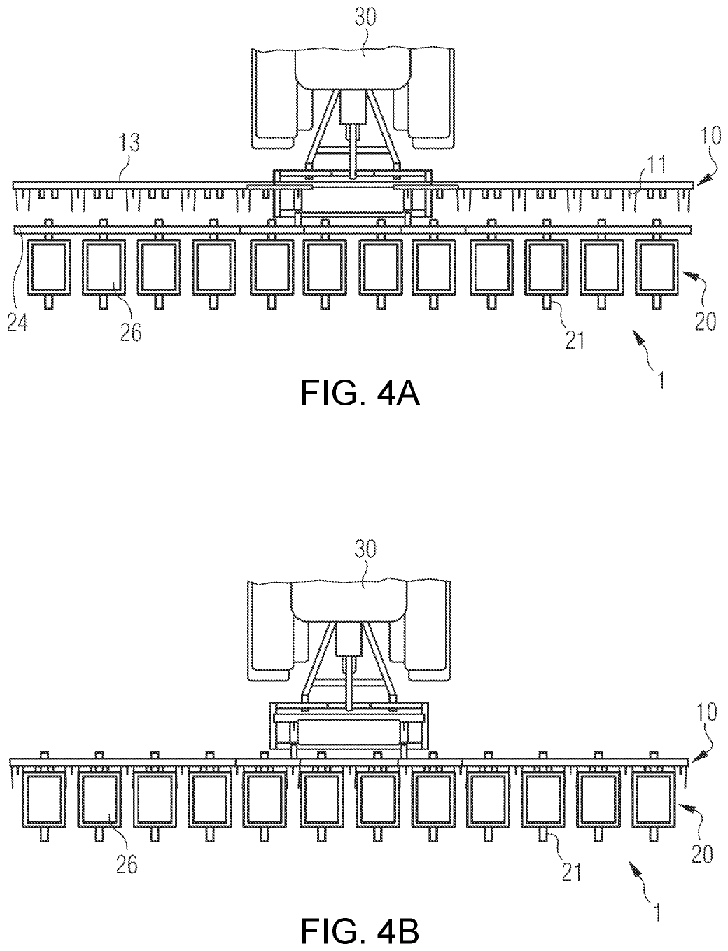

In FIG. 4A, the first module 10 and the second module 20 are shown in detail arranged one behind the other at the rear of the carrier vehicle 30 in plan view. FIG. 4B differs only in that the first module 10 and the second module 20 are arranged in close spatial proximity to one another and the transition resistance-reducing liquid 15 can be sprayed directly in front of the applicators 21 or the electrical applicators 21 can be acted upon directly by the nozzle 11. The applicators 21 are arranged side by side such that they can operate to cover an area or can be spaced apart for row crops as shown in the figure. For row cultures, a segmented arrangement is also necessary to protect the crop plants, which is produced by moving the applicators 21 apart on the support structure 24 or by lifting out individual applicators 21. By means of stripping devices 12 or leaf lifters, cultivated plants can be treated very closely due to their regular position. The stripping devices 12 are insulated on the side surfaces, but are usually conductive at the edges where they contact the ground, so that downpressed crop leaves that may be contacted by applicators 21 are safely grounded and do not pass current into the crop. The individual applicators 21 have safety covers 26 and, if necessary, further spacers to the outside for setting safety distances.

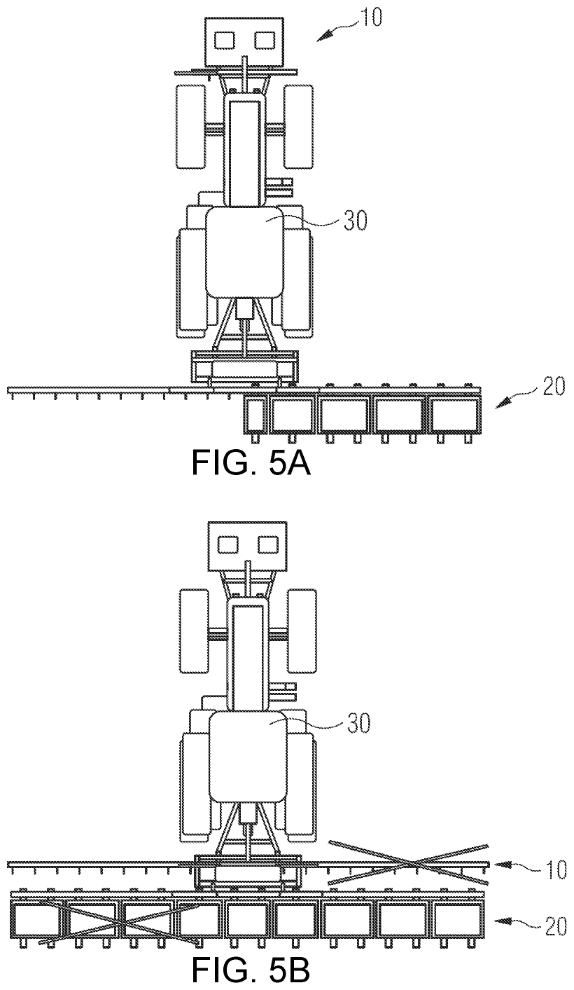

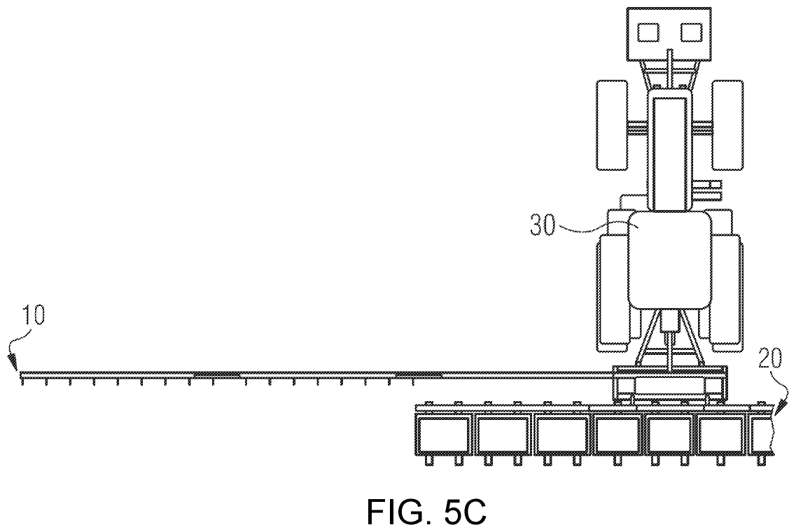

FIGS. 5A, 5B and 5C show possible arrangements of the first module 10 and the second module 20. The examples of embodiments relate to an apparatus 1 for applying a transition resistance-reducing medium 15 and an electrophysical treatment at one-minute intervals. Of the possible total working width of the apparatus 1, one half is actively used only for the distribution of the medium 15 by means of the first module 10, while on the other half the second module 20 applies electrical current on the surface already chemically treated during the previous pass. In the embodiment in accordance with FIG. 5A, the first module 10 and the second module 20 are each only half populated. In the embodiment in accordance with FIG. 5B, the first module 10 and the second module 20 are each double loaded, but only half in operation and can be freely changed (FIG. 5B). In the embodiment in accordance with FIG. 5C, the first module 10 is separately movable or swing-out duplicated and can therefore be flexibly used on the right, left or simultaneously.

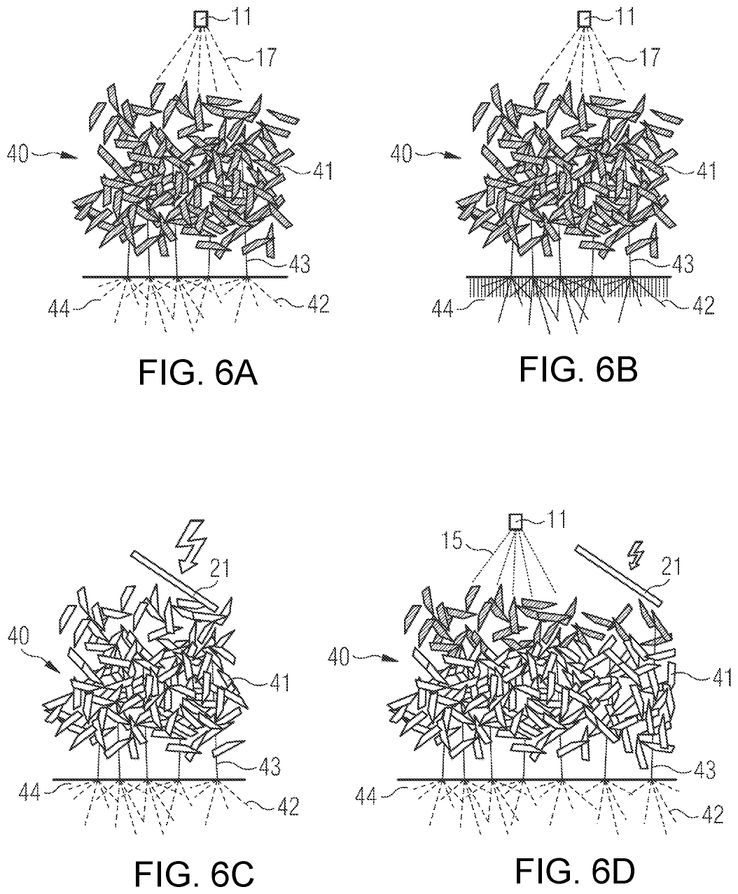

FIGS. 6A, 6B, 6C and 6D compare different herbicidal methods of plant treatments. In a conventional method in accordance with FIG. 6A, systemic non-selective herbicides 17 are applied to the plants 40 mainly by means of nozzles 11 from above and spread by the juice flow over all leaves 41 (hatching) into the roots 42, which are then also destroyed (dashing). A large proportion of these substances are now banned or are likely to be in the future. Their main effect is the disruption or alteration of chemical metabolic pathways in the plant, which then leads to its death down to the roots.

In a conventional method in accordance with FIG. 6B, non-selective contact herbicides 17 are applied to the leaves 41 and stems 43 as fully as possible by spraying (hatching), which requires large amounts of active ingredient and water and also increases direct wetting of the ground 44. Nevertheless, the effect is only on the leaves 41 and stems 43 (hatching). Root weeds are poorly controlled because the roots 42 are not killed directly (solid lines, not dashed). The action of contact herbicides can almost be considered physical in some cases, when its main effect is to damage the wax layer as an evaporation barrier.

In a conventional method in accordance with FIG. 6C, electrophysical methods are used wherein electrical current is applied to the plants 40 from above, which can damage them to the root 42. The main mechanism of action is the destruction of water-conducting vessels in the stems (petioles) 43 and roots 42, which then leads to desiccation into the roots 42. However, this requires a lot of energy and high voltages to overcome the resistance barrier between leaf 41 and applicator 21. The electrical applicator 21 needs only to touch the leaves 41 in the upper area of the plant 40 to pass the current through the leaf 41 and stem (petioles) 43 into the roots 42 to kill them.

In the embodiment of the method according to the invention in accordance with FIG. 6D, a synergistic effect is achieved by combining resistance-lowering liquid 15 and electrophysical treatment. The transition resistance-reducing liquid applied only to the uppermost leaf level reduces the resistance at the transition surface from applicator 21 to leaf 41, thereby reducing the voltage and electrical power required. This systemically destroys the plant 40 down to the root 42. In many cases, it is possible to completely dispense with substances that are subject to the Plant Protection Products Act or are not permitted in the organic area.

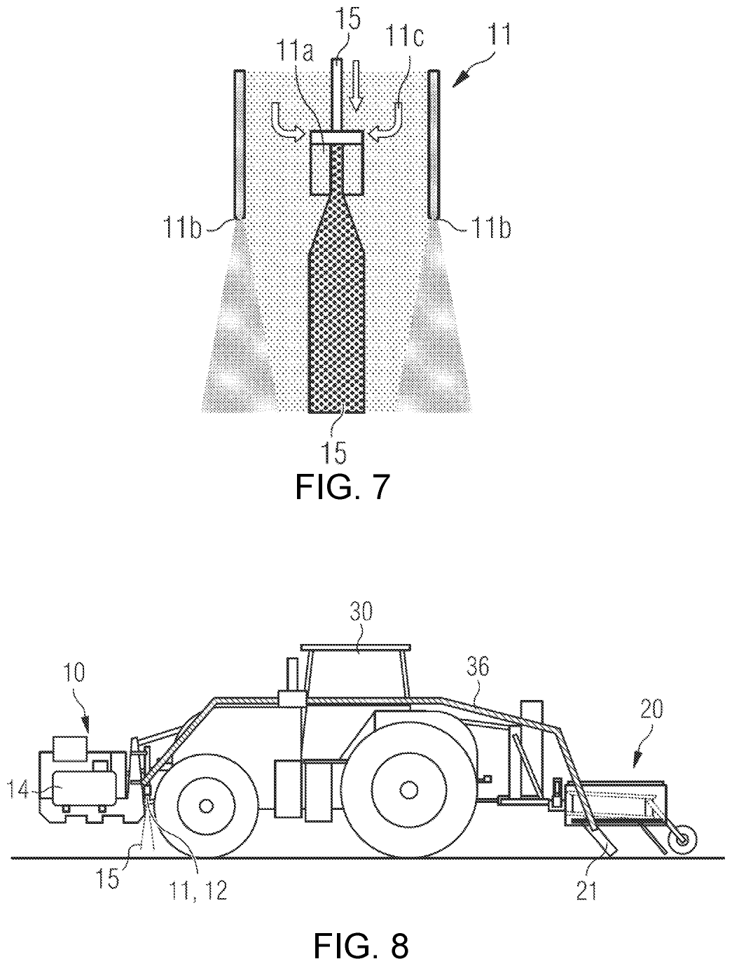

FIG. 7 shows an embodiment of a nozzle 11 (cross-sectional view). The nozzle 11 is designed here as a sheath or surface flow nozzle for the application of hot oil 15. In this example of embodiment, the hot oil 15 is the transition resistance-reducing medium. To ensure that the hot aqueous or oily spray jet 15, in particular the hot oil mist 15, reaches the plants in a targeted manner even in the event of wind drift and cools only as little as possible, it is useful to use aspirated gases 11c for the spray nozzle 11a itself and hot exhaust gases or specially heated electric air for the sheath or surface nozzles 11b (air blades).

In accordance with the embodiment of FIG. 8, exhaust gas streams from the carrier vehicle 30 can be used to heat the transition resistance-reducing liquid 15, and possibly also the spray air, the application device 11, 12 and/or the applicators 21. In accordance with FIG. 8, exhaust gas from the exhaust gas stream is directed to the application device (nozzle 11, scraper 12) and the application apparatus 21. For this purpose, the exhaust gas is pressurized (10-300 mbar) with fans capable of handling hot air and conducted to the points of use in insulated pipes (exhaust gas line pipes) 36. As an alternative or in addition to the use of exhaust gas heat, electric heating apparatuses, for example, can also be used.

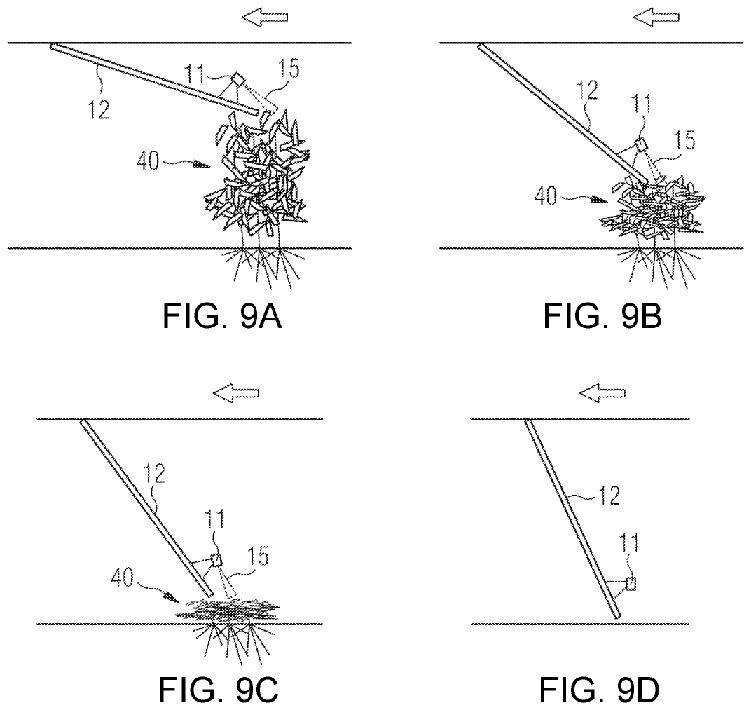

FIGS. 9A, 9B, 9C and 9D show an example of an application device for selectively spraying transition resistance-reducing liquids 15 directly onto a plant 40. The liquid 15 is sprayed through one or more nozzles 11 arranged next to one another in large drops and, if possible, only onto the uppermost leaf level. Short spray paths allow the temperature in the spray solution (spray liquid) to be better maintained. The nozzles 11 are arranged on light scrapers 12 resting on the plants, which are flexibly (e.g., via a joint or elastically) suspended from the support structure 13. The nozzle orientation on the scrapers 12 is rigidly angled downward. The flexible arrangement of the scraper 12 on the support structure 13 allows the height of the application device 11, 12 to be adapted to the growth height of the plants 40 (FIG. 9A: high growth height, FIG. 9B: medium growth height, FIG. 9C: small growth height, FIG. 9D: no plants). The arrow shows the direction of movement of the apparatus 1.

Exemplary parameters of the nozzles 11 and the scraper 12 in accordance with the arrangement of FIGS. 9A, 9B, 9C and 9D are shown in Table 5.

TABLE 5

| Technical | Secondary | | | | | | |
|---|---|---|---|---|---|---|---|
| parameters | parameters | general | | preferred | | in particular | |
| Scraper length | Length generally | 24-200 | cm | 35-150 | cm | 60-120 | cm |
| | 20-50% greater than | | | | | | |
| | distance from | | | | | | |
| | ground | | | | | | |
| Distance | | 20-150 | cm | 30-100 | cm | 50-80 | cm |
| equipment frame- | | | | | | | |
| ground | | | | | | | |
| Scraper width | The more | 10 cm- | | 10 cm- | | 10 cm- | |
| | inhomogeneous and | 100 cm | | 50 cm | | 20 cm | |
| | smaller the plants, | | | | | | |
| | the narrower | | | | | | |
| Scraper material | | Plastic | | GRP/POM | | GRP POM | |
| Contact pressure | Low values in | 0.1-30 | kg/m | 0.3-15 | kg/m | 0.5-5 | kg/m |
| at the lower end of | grasses; High | | | | | | |
| the scraper | values in woody | | | | | | |
| | plants >50 cm | | | | | | |
| Distance of the | Correlated with flow | 10 cm- | | 10 cm- | | 10 cm- | |
| nozzles laterally | rate and opening | 100 cm | | 50 cm | | 20 cm | |
| | angle, scraper width | | | | | | |
| Nozzle opening | | 10°- | | 20°- | | 20°- | |
| angle | | 130° | | 80° | | 50° | |
| Nozzle heating | Optional | Current/ | | Exhaust | | Exhaust | |
| | | exhaust gas | | gas | | gas | |
| Nozzle | aqueous/oil-based | 1-99° C./ | | 5-90° C./ | | 5-80° C./ | |
| temperature | | 1-300° C. | | 10-280° C. | | 5-250° C. | |
| Nozzle material | Aqueous media | Plastic | | Plastic | | Plastic | |
| | organic based | Plastic/Metal | | Metal | | Metal | |
| | media (especially | | | | | | |
| | above 90° C.) | | | | | | |
| Flow rate of the | Adjusted to travel | 0.05 l/min- | | 0.05 l/min- | | 0.05 l/min- | |
| nozzle | speed by pressure | 0.5 l/min | | 0.5 l/min | | 0.5 l/min | |
| | change | | | | | | |
| Pressure range | Adjusts flow rate | 0.1-5 | bar | 0.5-2.5 | bar | 1 bar- | |
| | | | | | | 2 bar | |
| Application | When the surface is | 5-1000 | L/ha | 10-200 | l/ha | 15-50 | l/ha |
| quantity | completely covered | | | | | | |
| | with vegetation | | | | | | |
| Droplet size | according to ISO | F, M, | | M, G, -SG, — | | G, -SG, | |
| | 25358 | G, -SG, EG | | | | | |
| Distance of plant | | 10-100 | cm | 10-50 | cm | 10-20 | cm |
| to nozzles | | | | | | | |

| | | | | |
|---|---|---|---|---|
| Nozzle orientation | Deviation from | 5°- | 10°- | 10- |
| relative to scraper | parallel alignment | 70° | 45° | 30° |

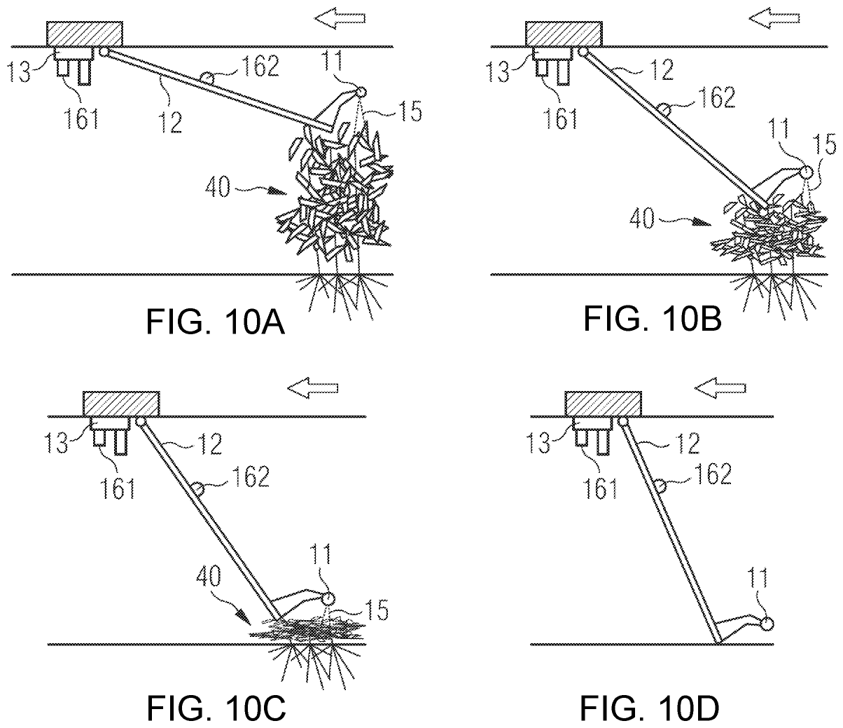

FIGS. 10A, 10B, 10C and 10D shows another example of embodiment for an application device 11, 12 for selectively spraying transition resistance-reducing liquids 15 directly onto plants 40. In contrast to the embodiment of FIGS. 9A, 9B, 9C and 9D, the nozzle orientation here is dynamic and, controlled by gravity, always directs itself downward by means of a gimbal suspension and weighting at the lower end, whereby an application is always achieved from above precisely to the areas that are also reached by the electric applicators 21. The on/off spraying or flow rate of medium 15 can be controlled by optical sensors 161 permanently mounted on the frame (e.g., for image recognition or fluorescence analysis with active illumination) and/or with a sensor 162 on the scraper 12 that is sensitive to position and distance and whose setting corresponds to the plant size (e.g., by raising the scraper 12, i.e., a change in angle means: Plants under scraper, or by measuring distance to frame by metal detector). The flexible arrangement of the scraper 12 on the first support structure 13 and the dynamic nozzle orientation allows the height of the application device 11, 12 to be adapted to the growth height of the plants 40 (FIG. 10A: high growth height, FIG. 10B: medium growth height, FIG. 10C: small growth height, FIG. 10D: no plants). The arrow shows the direction of movement of the apparatus 1.

Exemplary parameters of the nozzles 11 and the scraper 12 in accordance with the arrangement of FIGS. 10A, 10B, 10C and 10D are shown in Table 6.

TABLE 6

| Technical | Secondary | | | | | | |
|---|---|---|---|---|---|---|---|
| parameters | parameters | general | | preferred | | in particular | |
| Scraper | Length generally | 24-200 | cm | 35-150 | cm | 60-120 | cm |
| length | 20-50% greater than | | | | | | |
| | distance from ground | | | | | | |
| Distance | | 20-150 | cm | 30-100 | cm | 50-80 | cm |
| equipment | | | | | | | |
| frame-ground | | | | | | | |
| Scraper width | The more | 10 cm- | | 10 cm- | | 10 cm- | |
| | inhomogeneous and | 100 cm | | 50 cm | | 20 cm | |
| | smaller the plants, the | | | | | | |
| | narrower | | | | | | |
| Scraper | | Plastic/Metal | | GRP/POM/ | | GRP/POM/PU/ | |
| material | | | | PU/Metal | | Stainless | |
| | | | | | | steel | |
| Contact | Low values in grasses | 0.1-30 | kg/m | 0.3-15 | kg/m | 0.5-5 | kg/m |
| pressure at | High values in woody | | | | | | |
| the lower end | plants >50 cm | | | | | | |
| of the scraper | | | | | | | |
| Distance of | Correlated with flow | 10 cm- | | 10 cm- | | 10 cm- | |
| the nozzles | rate and opening angle, | 100 cm | | 50 cm | | 30 cm | |
| laterally | scraper width | | | | | | |
| Nozzle | | 10-130° | | 20°-80° | | 20°-50° | |
| opening angle | | | | | | | |
| Nozzle | Optional | Current/ | | Exhaust | | Exhaust | |
| heating | | exhaust gas | | gas | | gas | |
| Nozzle | aqueous/oil-based | 1-99° C./ | | 5-90° C./ | | 5-80° C./ | |
| temperature | | 1-300° C. | | 10-280° C. | | 5-250° C. | |
| Nozzle | Aqueous media | Plastic | | Plastic | | Plastic | |
| material | | | | | | | |
| | organic based media | Plastic/Metal | | Metal | | Metal | |
| | (above 90° C.) | | | | | | |
| Flow rate of | Adjusted to travel | 0.05 l/min- | | 0.05 l/min- | | 0.05 l/min- | |
| the nozzle | speed by pressure | 0.5 l/min | | 0.5 l/min | | 0.5 l/min | |
| | change | | | | | | |
| Pressure | adjusts flow rate | 0.1-5 | bar | 0.5-2.5 | bar | 1 bar- | |
| range | | | | | | 2 bar | |
| Application | When the surface is | 5-1000 | L/ha | 10-200 | l/ha | 15-50 | l/ha |
| quantity | completely covered with | | | | | | |
| | vegetation | | | | | | |
| Droplet size | according to ISO 25358 | F, M, | | M, G, -SG, — | | G, -SG, | |
| | | G, -SG, EG | | | | | |
| Distance of | | 10-100 | cm | 10-50 | cm | 10-20 | cm |
| plant to | | | | | | | |
| nozzles | | | | | | | |

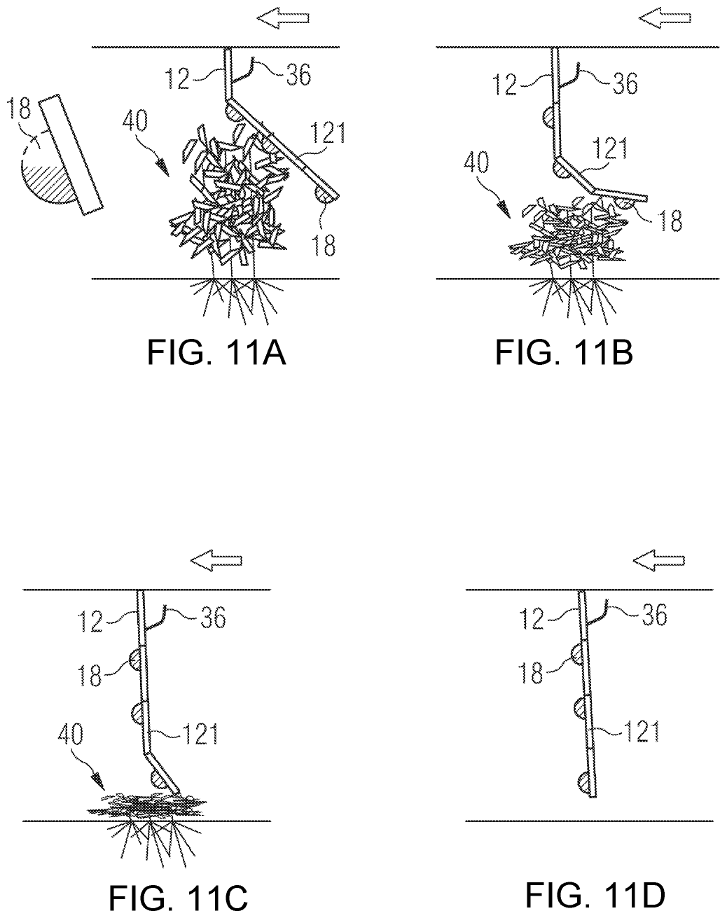

FIGS. 11A, 11B, 11C and 11D show another example of embodiment for an application device 11, 12 for selectively spraying transition resistance-reducing liquid 15 directly onto plants 40, in which the transition resistance-reducing liquid 15 is heated. Preferably and for insulation reasons, heating is performed with hot exhaust gases, which are fed to the scraper 12 (which has, for example, plastic plates with hinges made of flexible material (rubber, polyurethane (PU)) or is provided completely made of flexible material, e.g., PU, or for high temperatures made of stainless steel), via a line (exhaust gas line pipe) 36. However, insulating oils can also be passed through conduit 36 for heating. Alternatively, the scrapers 12 can be heated with electrical current. The scrapers 12 have a similar basic geometry to the electric applicators 21. They can also have attachments, possibly combined with grooves and passages, which allow capillary or pressure-conveyed free or controlled media transport. Individual dosing elements 18 are mounted on or in the rigid or flexible scrapers in such a manner that large plants are always supplied with more transition resistance-reducing medium 15 than smaller plants. Dosing can be controlled by means of sensors (e.g., by means of current/voltage sensors, optical sensors 161, position or movement sensors 162) or, for example, by passing small sample currents through segments 121 of the scraper 12. RFID-based sensors are preferably used for all non-optical measurements on the applicators 21 in order to save cables, etc. and to avoid costly high-voltage isolations. Preferably, deflection-controlled scrapers 12 are also used: The more the scraper 12 is deflected, the more transition resistance-reducing liquid 15 can escape from the supply pipe due to the perforation or the displacement of the cover. The flexible arrangement of the scrapers 12 on the support structure 13 and the segmented design of the scrapers 12 allows the height of the application device 11, 12 to be adapted to the growth height of the plants 40 (FIG. 11A: high growth height, FIG. 11B: medium growth height, FIG. 11C: small growth height, FIG. 11D: no plants). The arrow shows the direction of movement of the apparatus 1.

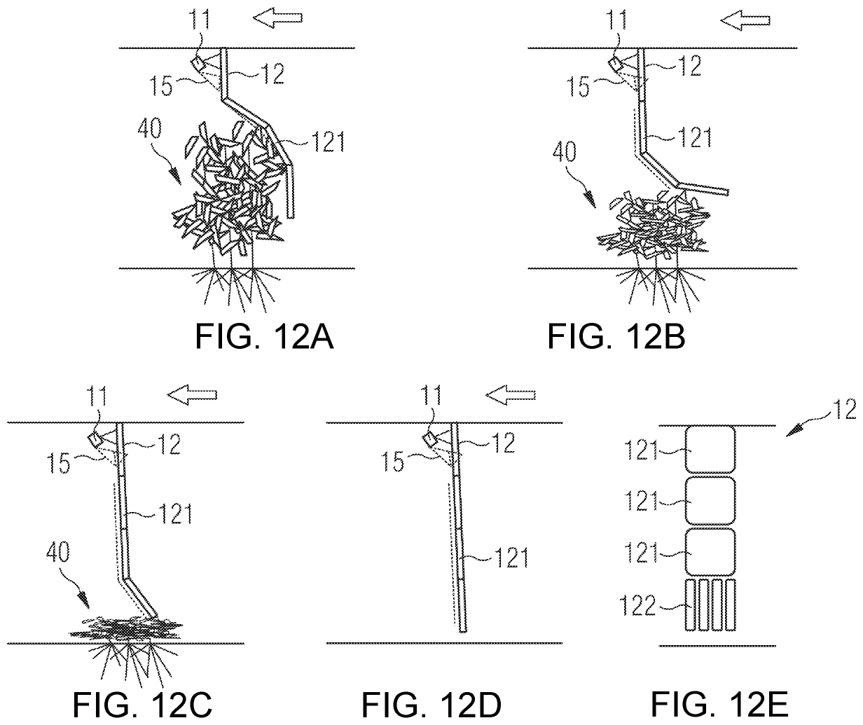

FIGS. 12A, 12B, 12C, 12D and 12E show another example of embodiment for an application device 11, 12 for selectively spraying transition resistance-reducing media 15 directly onto plants 40, in which the transition resistance-reducing media 15 is sprayed onto the scrapers 12. The scrapers 12 then strip the transition resistance-reducing medium 15 exactly where the electrical applicators 21 are to contact the plants 40. The scrapers 12 can be heated, wherein the heating is preferably and for insulation reasons done with hot exhaust gases, but can also be done with insulating oils. The sprayed-on scrapers 12 have a similar basic geometry to the electric applicators 21. They have grooves and passages that allow spraying from the front or rear. Otherwise, they have a material as described for the embodiment in accordance with FIG. 11. The segmented design of the scrapers 12 allows the height of the scrapers 12 to be adapted to the growth height of the plants 40 (FIG. 12A: high growth height, FIG. 12B: medium growth height, FIG. 12C: small growth height, FIG. 12D: no plants). The spray intensity can be controlled by deflection of the applicators, optical sensors 161, or, for example, by passing small sample currents along even further subdivided scraper segments, referred to here as longitudinal segments 122 (FIG. 12E). RFID-based technologies are preferably used for all non-optical measurements on the applicators 21 in order to save cables etc. and to avoid costly high-voltage isolations. The arrow shows the direction of movement of the apparatus 1.

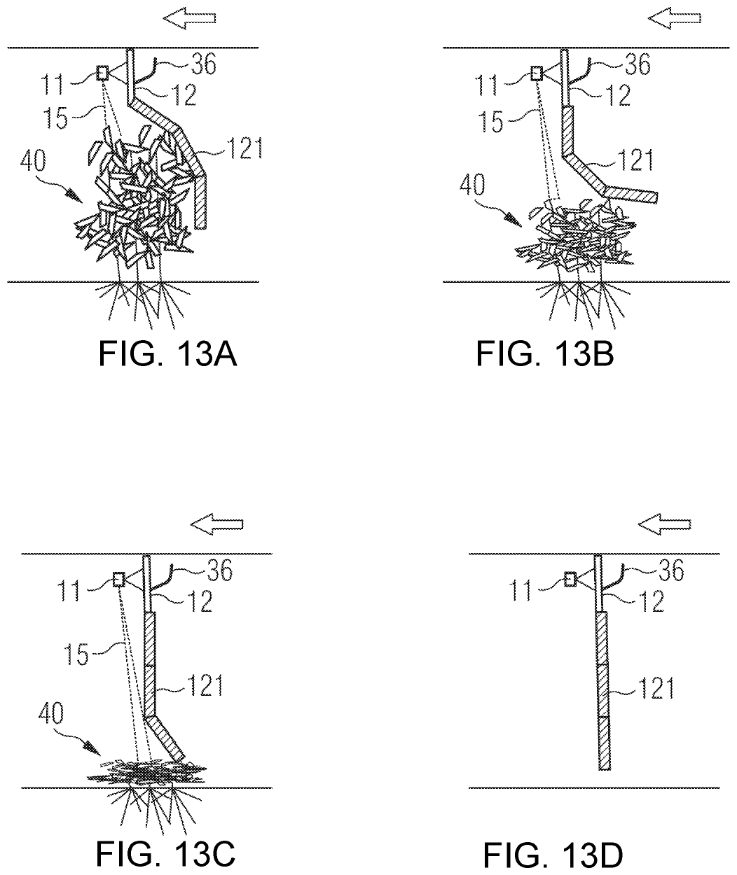

FIGS. 13A, 13B, 13C and 13D shows another example of embodiment for an application device 11, in which the nozzle 11 is arranged on the uppermost segment 121 of the scraper 12. The scraper 12, due to its shape similar to the electric applicators 21, is designed to ensure that the transition resistance-reducing medium sprayed by means of the nozzle 11 is sparingly wiped off precisely on those parts of the plant which are later also touched by the electric applicators 21. The segmented design of the scraper 12 enables the height of the application device 11, 12 to be automatically adjusted to the growth height of the plants 40 (FIG. 13A: high growth height, FIG. 13B: medium growth height, FIG. 13C: small growth height, FIG. 13D: no plants), in particular to their outer contour.

Alternatively or additionally to the heated spray medium, the scraper surface can also be heated (not shown). The scraper 12 is made of electrically and thermally non-insulated metal on the use side. The exhaust gases are conducted downwards via a pipe 36, preferably in the hollow scraper, and heat the electrically and thermally conductive scraper base, preferably in countercurrent (gas flow against the direction of movement). Due to the cooling of the exhaust gases as they rise toward the gas outlet at the top of the scraper 12 by heat transfer, the plants 40 are first contacted with the relatively colder upper scraper part, and then streak downward into the increasingly hot scraper zone. This allows the energy transfer to be optimized and energy consumption to be minimized by keeping the temperature differences between the scraper surface and the plant surface as constant as possible. The back of all scraper surfaces is thermally and electrically insulated (e.g., heat-resistant plastic foam (e.g., Bakelite foam)) to minimize energy losses and sparking.

Table 7 summarizes parameters of application device 11, 12 with scrapers 12 having multiple segments 121.

| Technical | Secondary | | | | | | |
|---|---|---|---|---|---|---|---|
| parameters | parameters | general | | preferred | | in particular | |
| Scraper length | Length generally | 24-200 | cm | 35-150 | cm | 60-120 | cm |
| | 20-50% greater than | | | | | | |
| | distance from ground | | | | | | |
| Distance | | 20-150 | cm | 30-100 | cm | 50-80 | cm |
| equipment | | | | | | | |
| frame-ground | | | | | | | |
| Scraper width | The more inhomo- | 10 cm- | | 10 cm- | | 10 cm- | |
| | geneous and smaller the | 100 cm | | 50 cm | | 20 cm | |
| | plants, the narrower | | | | | | |
| Number (for | As parts of the total | 2-6/12- | | 2-5, 15- | | 2-4/30- | |
| single links) and | length, can be | 100 cm | | 80 cm | | 70 cm | |
| length of | asymmetrical | | | | | | |
| scraper links | | | | | | | |
| Scraper material | For temps above 90° C. | Plastic | | GRP/POM | | GRP POM | |
| | always GRP or nylon or | back | | back | | back | |
| | PU, for temps above | insulated, | | insulated, | | insulated, | |
| | 200° C. stainless steel | foamed | | foamed | | foamed | |
| | with heat-resistant | plastic, | | plastic, | | plastic, | |
| | insulation (e.g., Bakelite | Stainless | | Stainless | | Stainless | |
| | foam). | steel | | steel | | steel | |
| Contact | Low values in grasses | 0.1-30 | kg/m | 0.3-15 | kg/m | 0.5-5 | kg/m |
| pressure at the | High values in woody | | | | | | |
| lower end of the | plants >50 cm | | | | | | |
| scraper | | | | | | | |
| Distance of the | Correlated with flow rate | 10 cm- | | 10 cm- | | 10 cm- | |
| nozzles laterally | and opening angle, | 100 cm | | 50 cm | | 30 cm | |
| | scraper width | | | | | | |
| Nozzle opening | | 10-130° | | 20°-80° | | 20°-50° | |
| angle | | | | | | | |
| Nozzle heating/ | Optional | Current/ | | Exhaust gas | | Exhaust gas | |
| Scraper heating | | exhaust gas | | | | | |
| Nozzle | aqueous/oil-based | 1-99° C./ | | 5-90° C./ | | 5-80° C./ | |
| temperature | | 1-300° C. | | 10-280° C. | | 5-250° C. | |
| Scraper | | | | | | | |
| temperature | | | | | | | |
| Nozzle material | Aqueous media | Plastic | | Plastic | | Plastic | |
| | organic based media | Plastic/Metal | | Metal | | Metal | |
| | (above 90° C.) | | | | | | |
| Flow rate of the | Adjusted to travel speed | 0.05 l/min- | | 0.05 l/min- | | 0.05 l/min- | |
| nozzle | by pressure change | 0.5 l/min | | 0.5 l/min | | 0.5 l/min | |
| Pressure range | adjusts flow rate | 0.1-5 | bar | 0.5-2.5 | bar | 1 bar- | |
| | | | | | | 2 bar | |
| Application | When the surface is | 5-1000 | L/ha | 10-200 | l/ha | 15-50 | l/ha |
| quantity | completely covered with | | | | | | |
| | vegetation | | | | | | |
| Droplet size | according to ISO 25358 | F, M, | | M, G, -SG, — | | G, -SG, | |
| | | G, -SG, EG | | | | | |
| Distance | | 10-50 | cm | 10-30 | cm | 10-20 | cm |
| nozzles scraper | | | | | | | |

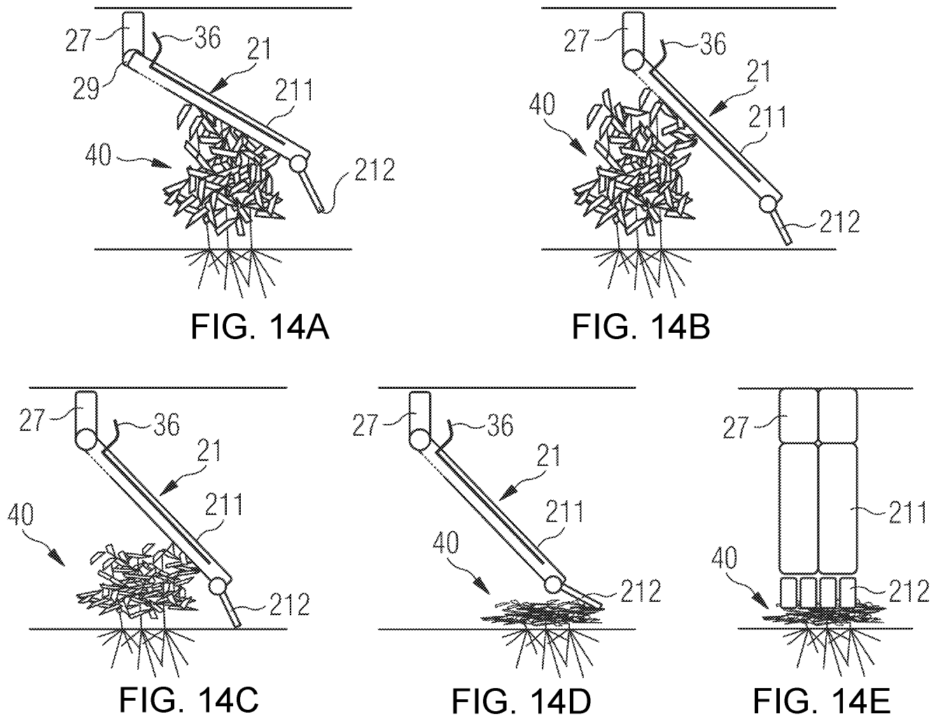

FIGS. 14A, 14B, 14C, 14D and 14E show an embodiment of an applicator 21 of a second module 20, through which electrical current is transmitted to the plants 40. The applicators 21 have an electrical material, such as metal, and may also be made entirely of one or more metals or alloys. The applicators 21 are attached to the second support structure 24 at an oblique angle, preferably 45°, but more importantly depending on the plants 40 in question, by means of a holder 27 with a lower stop (joint or flexible plastic or flexible metal). The formation of the electric applicator 21 in segments 211 allows the height of the application apparatus 11, 12 to be adapted to the growth height of the plants 40 (FIG. 14A: high growth height, FIG. 14B: medium growth height, FIG. 14C: small growth height, FIG. 14D: no plants). At the lower end of the applicator is a slightly movable contact segment 212 with ideally insulated end for spark prevention, wherein the height of the contact segment 212 is adjusted, for example, via a hinge connection to the next segment 211 after it, or it rests flexibly on the ground, or comes close to it in a defined manner. An applicator 21 may have multiple contact segments 212 arranged in parallel (FIG. 14E).

Very small plants 40 (preferably <5 cm in height) are only touched by the applicator 21, which is not actively heated, and current is passed through them. Preferred embodiments are those in which flexible contact segments 212 are thermally conductively connected to the heated applicator 21 and are thus also heated to some extent. Here, the applied transition resistance-reducing medium 15 and current are sufficiently effective. For larger plants 40 (preferably >5 cm in height), it is intended to graze along the heated applicator 21. The larger the plants 40 are, the longer the contact time at the inclined surface of the applicator 21 and the resulting contact pressure. Only very large and rigid plants (preferably higher than approximately 60% of the distance ground to applicator end/hinge 29) can lift the heated applicator 21, also for safety reasons. The applicator 21 has an electrically and thermally non-insulated metallic material on the side contacting the plants 40. To heat the applicator 21, exhaust gases are directed downward into the hollow applicator 21 via a pipe 36 and heat the electrically and thermally conductive applicator base, preferably using the countercurrent principle (gas flow against the direction of movement). Due to the cooling of the exhaust gases in the direction of a gas outlet at the upper end of the applicator 21, the plants are first contacted with the relatively colder upper applicator part and then streak downward into the increasingly hot applicator zone. This allows the energy transfer to be optimized and the energy consumption to be minimized by keeping the temperature differences between the applicator surface and the plant surface as constant as possible. The back of all applicator surfaces are thermally and electrically insulated (e.g., using heat-resistant plastic foam, such as Bakelite foam) to minimize energy loss and sparking.

Table 8 summarizes parameters of the application devices.

TABLE 8

| Technical | Secondary | | | | | | |
|---|---|---|---|---|---|---|---|
| parameters | parameters | general | | preferred | | in particular | |
| Scraper length | Length generally 20- | 24-200 | cm | 35-150 | cm | 60-120 | cm |
| | 50% greater than | | | | | | |
| | distance from ground | | | | | | |
| Distance | | 20-150 | cm | 30-100 | cm | 50-80 | cm |
| equipment | | | | | | | |
| frame-ground | | | | | | | |
| Scraper width | The more | 10 cm- | | 10 cm- | | 10 cm- | |
| | inhomogeneous and | 100 cm | | 50 cm | | 20 cm | |
| | smaller the plants, the | | | | | | |
| | narrower | | | | | | |
| Number (for | As parts of the total | 2-6/12- | | 2-5, 15- | | 2-4/30- | |
| single links) | length, can be | 100 cm | | 80 cm | | 70 cm | |
| and length of | asymmetrical | | | | | | |
| the scraper | | | | | | | |
| links | | | | | | | |
| Scraper | For temps above 90° C. | Plastic | | GRP/POM | | GRP POM | |
| material | always GRP or nylon | back | | back | | back | |
| | or PU, for temps | insulated, | | insulated, | | insulated, | |
| | above 200° C. stainless | foamed | | foamed | | foamed | |
| | steel with heat- | plastic, | | plastic, | | plastic, | |
| | resistant insulation | Stainless | | Stainless | | Stainless | |
| | (e.g., Bakelite foam). | steel | | steel | | steel | |
| Contact | Low values in grasses | 0.1-30 | kg/m | 0.3-15 | kg/m | 0.5-5 | kg/m |
| pressure at the | High values in woody | | | | | | |
| lower end of | plants >50 cm | | | | | | |
| the scraper | | | | | | | |
| Distance of the | Correlated with flow | 10 cm- | | 10 cm- | | 10 cm- | |
| nozzles | rate and opening | 100 cm | | 50 cm | | 30 cm | |
| laterally | angle, scraper width | | | | | | |
| Nozzle | | 10-130° | | 20°-80° | | 20°-50° | |
| opening angle | | | | | | | |
| Nozzle | Optional | Current/ | | Exhaust | | Exhaust | |
| heating/ | | exhaust gas | | gas | | gas | |
| Scraper | | | | | | | |
| heating | | | | | | | |
| Nozzle | aqueous/oil-based | 1-99° C./ | | 5-90° C./ | | 5-80° C./ | |
| temperature | | 1-300° C. | | 10-280° C. | | 5-250° C. | |
| Scraper | | | | | | | |
| temperature | | | | | | | |
| Nozzle | Aqueous media | Plastic | | Plastic | | Plastic | |
| material | | | | | | | |
| | organic based media | Plastic/Metal | | Metal | | Metal | |
| | (above 90° C.) | | | | | | |
| Flow rate of | Adjusted to travel | 0.05 l/min- | | 0.05 l/min- | | 0.05 l/min- | |
| the nozzle | speed by pressure | 0.5 l/min | | 0.5 l/min | | 0.5 l/min | |
| | change | | | | | | |
| Pressure range | adjusts flow rate | 0.1-5 | bar | 0.5-2.5 | bar | 1 bar- | |
| | | | | | | 2 bar | |
| Application | When the surface is | 5-1000 | L/ha | 10-200 | l/ha | 15-50 | l/ha |
| quantity | completely covered | | | | | | |
| | with vegetation | | | | | | |
| Droplet size | according to ISO | F, M, | | M, G, -SG, — | | G, -SG, | |
| | 25358 | G, -SG, EG | | | | | |
| Distance | | 10-50 | cm | 10-30 | cm | 10-20 | cm |
| nozzles | | | | | | | |
| scraper | | | | | | | |

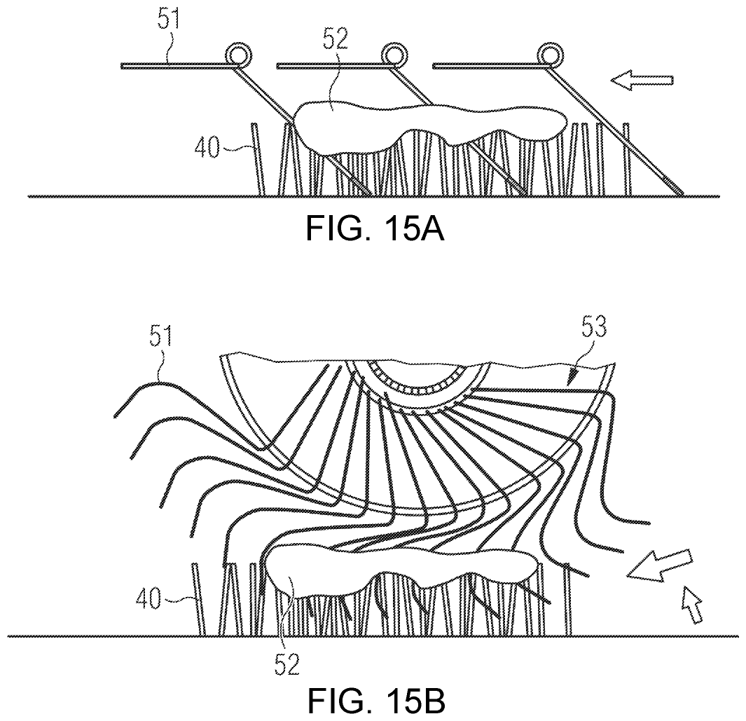

In embodiments of the applicators 21 in accordance with the embodiment of FIGS. 15A and 15B, the current is transmitted to grass-like plants 40 by means of moving wires 51. The power transfer is reinforced by using conductive hybrid foam 52. In FIG. 15A, the wires 51 are arranged in the form of combs that vibrate or exhibit self-movement. In FIG. 15B, the wires are arranged in the form of star wheel applicators 53. Other similar embodiments include plunging passively rotated brushes, counter-rotating brushes, wire elements or brushes running transverse to the direction of travel, and angled wire elements (not shown). While the comb-type wire elements/tines 51 (FIG. 15A) preferably move in the direction of travel and can only perform minor sideways vibrations, grass can be combed very strongly transverse to the direction of travel with the aid of ground-driven star wheel applicators 53 (FIG. 15B). For this purpose, the star wheel applicators 53 are also used with several star wheels on one axle, in contrast to the hay-turning uses. Wire elements running crosswise to the direction of travel are also similar in design to those of hay turners, except that the wire density is significantly higher in order to ensure that all plants are contacted directly or indirectly.

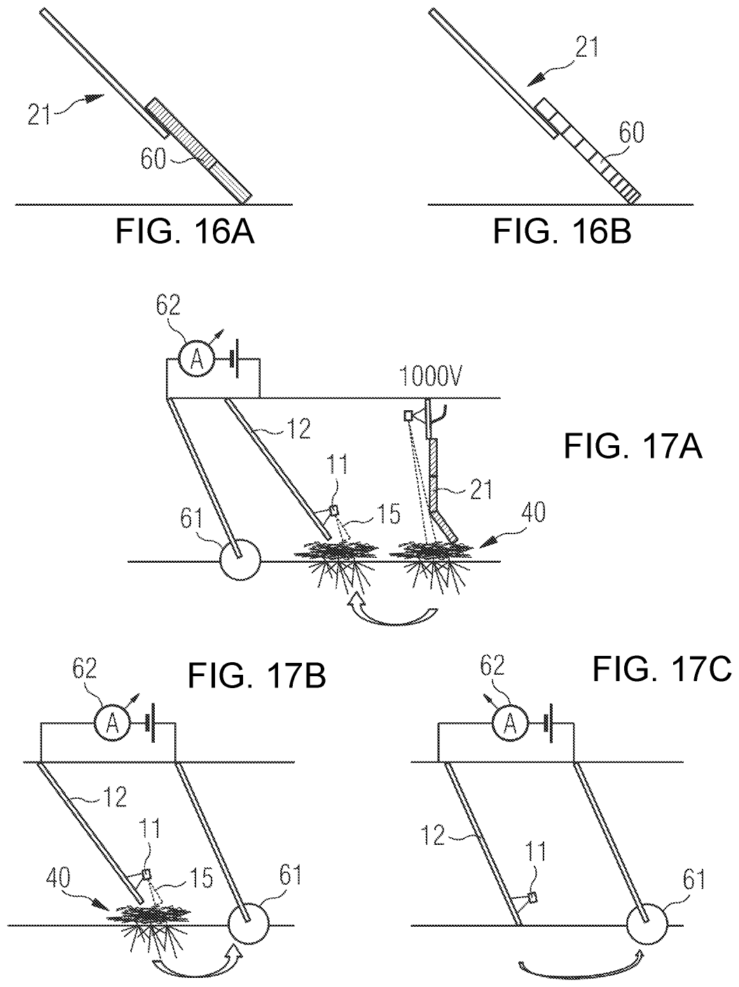

To avoid breakaway sparks, in one embodiment in accordance with the representation of FIGS. 16A and 16B, the end pieces of the applicators 21 have rough or porous applicator end pieces 60 with decreasing conductivity gradients and residual media stored therein, if any. The porous or materially less conductive lower portions 60 hold the plants to the ground and have progressively (A) or gradually (B) reduced electrical conductivity. This counteracts the formation of breakaway sparks as they are extinguished by the moisture or partially conductive material of the units or the settled ground or mixture of run-down/dispersed application liquid and applicator material. Possible materials of the end pieces 60 are glass or carbon fiber materials, polyurethanes with partially conductive fillers such as corundum or carbides, or conductive silicates, preferably surface elements made of separator disks and brake pads. Material thicknesses are between 3 and 30 mm, preferably 5-15 mm. The end pieces are attached to the lower ends of the applicators 21 with screws or clamps. In all cases, a non-conductive end portion can still be added to the end pieces, if necessary. The non-conductive applicator ends 60 may have tapered ends to cut off the air spark path of discharge sparks that normally propagate in the direction of travel.

FIGS. 17A, 17B and 17C show examples of an electronic control circuit for dosing the amount of transition resistance-reducing liquid to be applied. When the applicator 21 sits on the poorly conductive ground, a low current flows through the measuring circuit with its own power supply (e.g., voltage pulses analogous to fencing equipment) and a grounding disk 61 running safely in the ground. If there are plants 40 in the area of the applicator 21, they greatly lower the resistance and current flows at significantly higher levels. This can be measured by the measuring equipment 62, is then intermediately processed by an evaluation unit (not shown) with threshold setting and controls a valve shortly before the spray nozzle 11 so that the nozzle 11 sprays (FIG. 17A). Alternatively, the stray currents of the applicators 21 in the ground can be used, resulting in a potential field also in front of the actual application area. If a plant grows there, the measurable stray currents increase relative to an even more distant grounding disk 61 compared to measurements on bare earth. Based on this signal, the nozzle 11 is then switched (FIG. 17B). If no plant is growing, the measurable stray currents relative to an even more distant grounding disk 61 do not increase compared to measurements on bare earth; then nozzle 11 is not switched (FIG. 17C). If RFID-based current measurement units are sufficiently sensitive, the current measurement can be applied directly to the conductive applicator 21 and the application devices 11, 12 can be grounded together directly through the equipment frame very easily and inexpensively (not shown). The values are then interrogated contactlessly via radio and there is no risk of measuring equipment short-circuits due to the high voltage.

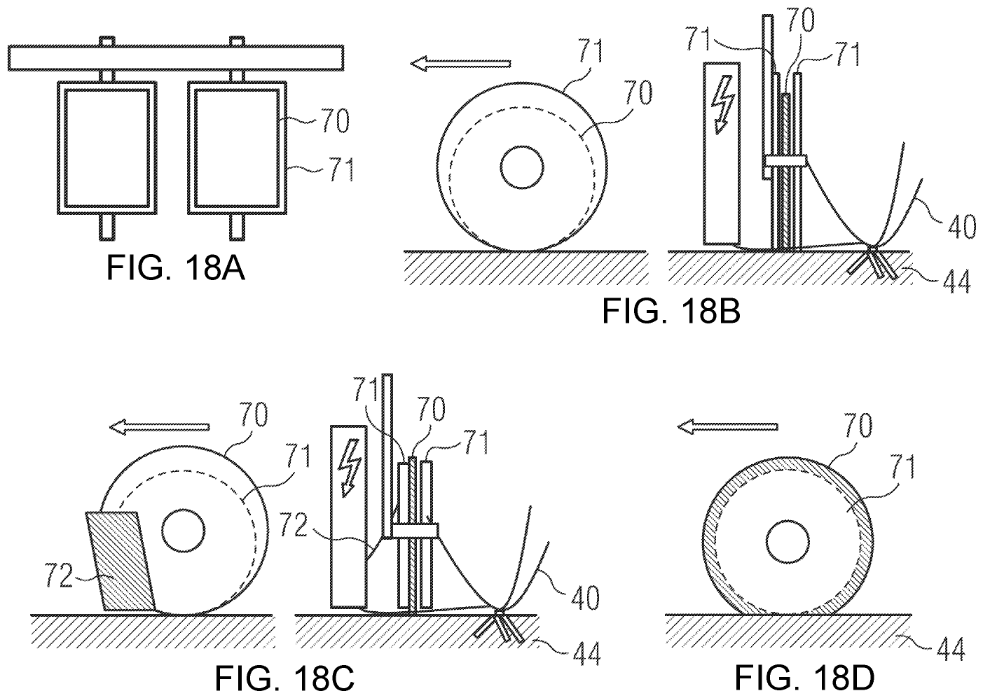

In FIGS. 18A, 18B, 18C and 18D, embodiments of protective disks 70 of insulating design are shown. These are intended to protect crops in untreated areas from electrical current. In this case, a non-conductive protective disk 71 is either firmly applied to the smooth or toothed protective disk 70 on both sides (FIG. 18A) or runs along the same axis, if necessary with a larger bore or a slightly shifted axis, in order to also cover the protruding metal edge in the air (FIG. 18B, left side view, right front view). Alternatively, the isolation disk may be provided with a ring of flexible bristles 72 (FIG. 18C, left side view, right front view), or there may be static scraper elements on the wheels (not shown). The metal disk preferably protrudes 2 to 10 mm beyond the plastic protective disks and can thus either cut off plant parts 40 on the ground or at least press them into the ground for electrical grounding. For this reason, no electrical current from the applicator 21 can flow from a touched leaf 41 of the crop plant into the root 42 of the crop plant.

Accordingly, the metal disk 70 is grounded by its own cutting into the ground or another grinding device (e.g., via the trailing support wheel) (FIG. 18D). The axis and the holder of the protective disks 70 are covered in an insulating manner. The arrow shows the direction of movement of the apparatus 1.

The effectiveness of apparatus 1 was tested in efficiency experiment. Efficiency experiment are performed based on the seasonal plant cover in the fields. Table 9 depicts an overview of the experiments.

TABLE 9

| Guide name of the | | Boundary condition/ |
|---|---|---|
| treatment | Classification | pretreatment |
| Greening spring | Mixed growth, especially | Regrowth after mulching |
| | grasses | |
| | Oelrettich | Regrowth after very shallow |
| | | cultivating |
| Sugar beet seedbed | Small weeds mixed | |
| preparation | | |
| Sugar beet | Small weeds mixed | 2-4 days after seed |
| preemergence | | |
| Post-harvest | Drop out potatoes | If necessary after shallow |
| | (small-large) I, Catch | cultivation |
| | crop in stubble (small). | |
| Nematode stop in | Emerging rape (small) | Mulching directly after |
| oilseed rape | after 200 temperature | harvest |
| | hours of emergence time | |
| Potato insurance | Siccation in different | Single and double |
| | potato varieties 1-3 | treatment, if necessary in |
| | weeks before harvesting | combination with |
| | | downstream siccation |
| | | herbicide |
| Row cultures corn, | Combat weeds between | |
| rape, potatoes | the rows of different | |
| | sizes | |
| Weakening of invasive | Treatment of extreme | After mowing 2-3 times a |
| plants | deep roots | year |

For all experiments, standard chemical herbicide (glyphosate, pelargonic acid), or standard physical/mechanical (haulm topping, shallow cultivating, hoeing) practices still allowed are carried as positive controls. Negative controls are always completely untreated strips. In addition, one strip is always treated with only the transition resistance-reducing medium and one with only the electrical current, respectively, to demonstrate the synergy of the two method components.

The experiments are run with 9 m wide equipment, wherein the working width of each electrophysical treatment unit is 50 cm or 1 m. In any case, 1 m wide strips are always treated the same. To exclude edge effects, the middle 50 cm of each 1 m wide strip is always evaluated over a length of 6 m.

For each treatment, three repetitions are normally provided, and five in the case of irregular growth.

Each experiment lane, which can be run in one piece, contains a sequence of treatment units in which the speed is kept constant for as long as possible and is only changed in blocks. Within each experiment lane, parameters such as the maximum tension, the maximum output per meter of working width and the application volume are changed before another speed is tested.

Since changes in applicators, application device positions (front, rear) and for switching between transition resistance-reducing media (different composition, different concentrations), require manual modifications to the experimental equipment, such changes can only be performed on different experimental lanes.

Between each individual treatment there are non-evaluable buffer areas of 10 m length in which the corresponding parameters on the spraying unit and electrophysical treatment are changed over. The changeover is either manual, but ideally GPS-controlled, assisted or completely automatic by the control unit of the overall system.

Only the two 3 m strips to the right and left of the tractor are evaluated in each case. The areas overrun by the tractor tires are basically excluded. The area between the tractor tires is used for zero controls and positive controls. Since the applying of the classical herbicides requires completely different spraying systems, these are done by a separate tractor with appropriate spraying boom, which sprays only the areas directly behind the tractor, thus creating the tracks for the later treatment. To eliminate any drift problems, the spray units are always placed in the transition areas. More than one type of spray control is applied in specific experiments because, for example, when using potato herbicides, but also glyphosate, farmers also do not always spray with a uniform dose. Here, the efficiency then becomes comparable with the various conventional dosages. The spray tractor for the control drives just before the transition resistance-reducing treatment. The area rolled over by the tractor tires and the area outside the tractor tires with up to 3 m total width then serves as a buffer strip to catch drift effects; this is not evaluated.

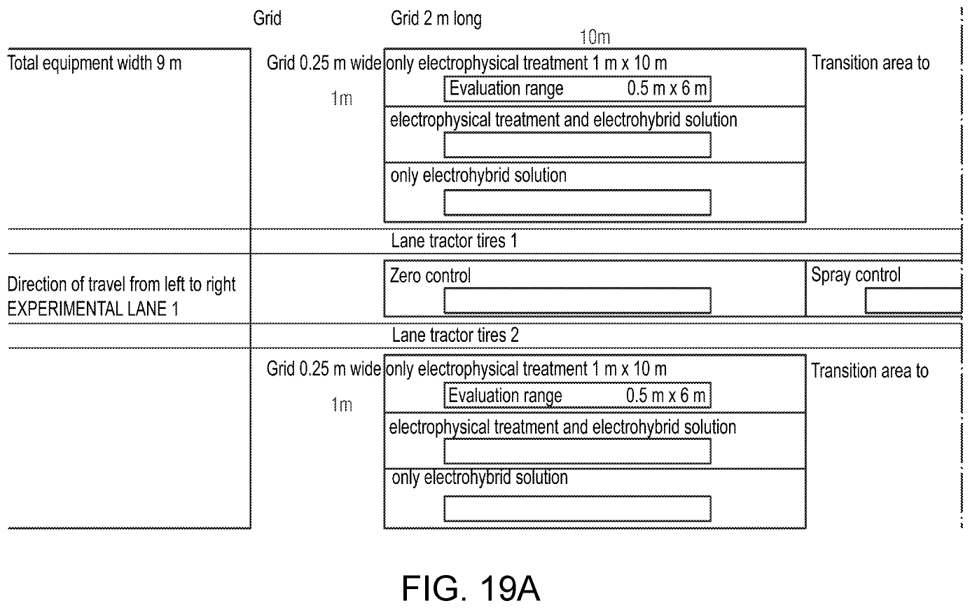

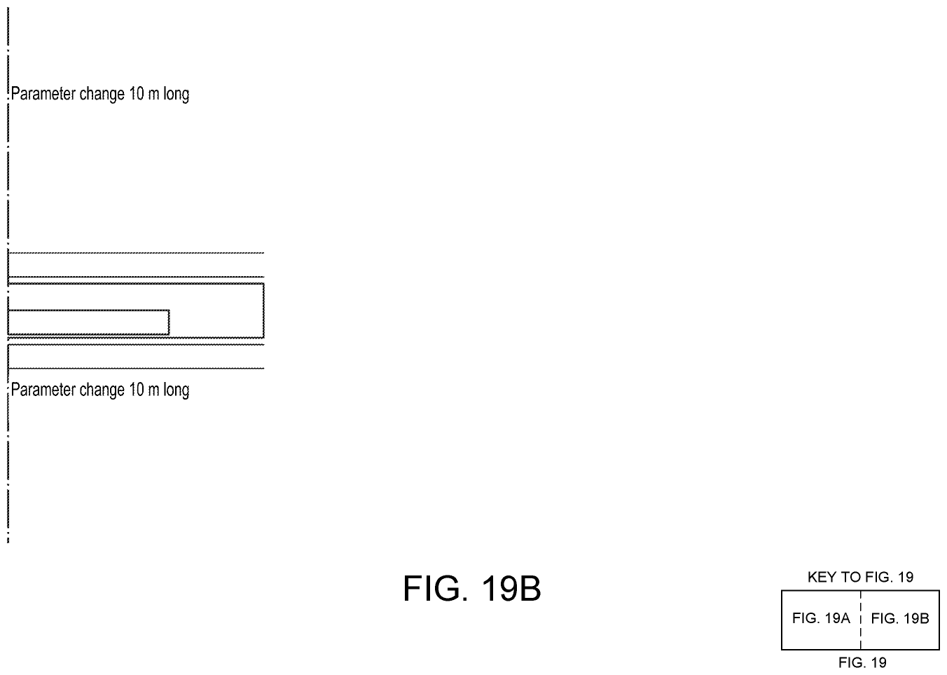

FIGS. 19A and 19B shows an experiment plan portion for performing a method according to the invention in an agricultural field. Here you can see a lane width corresponding to 9 m working width of the tractor, a treated portion (center) and a transition portion (right).

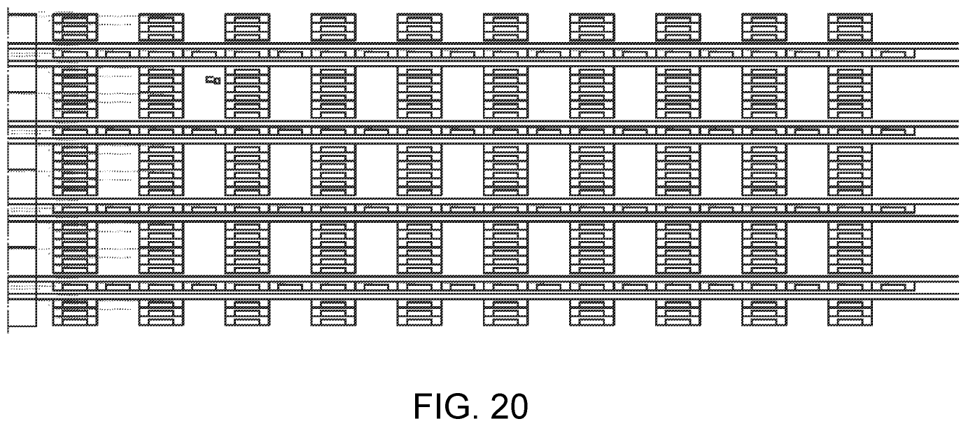

FIG. 20 shows an experimental field portion with a large number of plots, which are divided among the respective experiment links according to the rules mentioned in the text. Shown are 4 experiment lanes, each with 10 treatment units in a row.

Table 10 summarizes apparatus variants that are preferentially tested for efficiency. The parameters mentioned “in particular” are used as the respective detailed parameters if the experimental plants do not explicitly require other parameters as a special application.

TABLE 10

| | Transition resistance- | | |
|---|---|---|---|
| Culture | reducing medium | Application | Application type |
| Greening dicotyle | water-based/ oil- | Spraying, | heatable |
| Pre-emergence/seedbed | based | scraping | applicator, |
| sugar beet, canola, potato | | | simple metal |
| siccation, Row cultures | | | lamellae |
| Greening monocots | thixotropic | Spraying | Lamella |
| | | | applicator/ |
| | | | heatable |
| | | | applicators |
| Greening monocots | foaming | Spraying | Comb, star |
| | | | wheel, lamellae |

Table 11 summarizes variant ranges of the experiment variants.

TABLE 11

| Velocities | 4-12 | km/h |
|---|---|---|
| Current output | 2-20 | kW/m |
| Maximum voltage limit | 500-4000 | V |
| Concentrations/application rates of | low, medium, high (50%, 100% 200% | |
| transition resistance-reducing media | expected practical application rate)*. | |
| Amounts of water | 50-400 | l/ha |

| | |
|---|---|
| Application temperatures medium | Ambient temp. + 80° C./Ugt. + |
| (water/oil) | 80 + 160 + 240° C. |
| Scraper temperatures (water/oil) | Ambient temp. + 80° C./Ugt + |
| | 80 + 160 + 240° C. |
| Applicator temperatures (water/oil) | Ambient temp. + 80° C./Ugt + |
| | 80 + 160 + 240° C. |

*In the screening process, a concentration/ application rate of transition resistance-reducing medium is determined from preliminary experiments with various concentrations/application rates in flower boxes that is considered sufficient for the vast majority of plants. This application quantity is then additionally tested in the larger experiment, halved and doubled in each case, to check whether other concentrations/application quantities are even more effective in terms of economy and effect.

The exact experiment plans result from the size of the available fields, their format and the experiment parameters to be varied and are created according to the rules described above.

In each experiment variant, at least the following parameters are measured technically for each experiment plot:
Voltage,
Current,
Energy,
Frequency,
Weather,
Resistance

All parameters are measured with area resolution.

In each experiment variant, the following bonitures are performed:
Before treatment, 1 h, 1 day, 3 days, 7 days, 14 days after treatment.
Plant numbers,
Degree of damage,
Surface coverage,
special symptoms.

The experiments performed and their results are described below. The medium that lowers the electrical transition resistance is also referred to as a liquid.

### Experiment 1: Grain Treatment

Properties of the Experimental Field:

The experimental field is located on the outskirts of Wanlo in North Rhine-Westphalia, Germany (51° 05′56.3 ″N 6° 25′18.8 ″E). The ground type is described as parabrown earth. According to the mapping instructions of the Geological Survey of North Rhine-Westphalia, the material is clayey silt. The estimate of the value figure is very high at 75-85. The dry ground becomes very hard and shows massive dry cracks already in late, dry spring.

### Experimental Design

A vehicle, namely a tractor, with an apparatus according to the invention was used for the treatment of grain. A field sprayer with a working width of 6 m was attached to the front of the tractor as an application device. Attached at the rear of the tractor was the application device for applying electricity. In this case, the power generator was driven by the PTO shaft and had an output of up to 72 kW. 20 high-voltage units, each with 3.6 kW power, provided the nominal power in a voltage range between 2000 and 5000 V. The apparatus worked on 6 m width (working width). The application apparatus used were classic long applicators (also known as tongue applicators or LRBs) made of steel plates with a pole spacing of 60 to 80 cm, which were mounted across the entire working width. Tongue applicators were used as one pole and cutting disks in the ground as the second pole.

The treatment was tested in green wheat because it is a crop with very homogeneously growing, closely spaced plants. The plants are also upright, so that it is possible to introduce the current only into the leaves of the plants without further difficulty. In addition, grain represents a challenging application due to its robustness. At the time of treatment, ear emergence was already complete. At this point, for physiological reasons, rapid and complete killing of monocotyledonous plants with electricity alone is hardly possible, since lignification of the stems is already largely complete.

For the experiment, one lane length (excluding headland) of each lane of the experimental field was divided into five portions for four different speeds (in increasing order) and for one control without current (also referred to as liquid control or spray control). Each of the portions had a length of at least 10 m, or at least 20 m for 2 km/h and 4 km/h, respectively.

The portions were then treated according to the experimental design, first with water or different liquids (water with addition of Cocktail, Hasten, Polyaktiv or Bolero) and after a very short exposure time (approximately 4-8 s) with electricity using the tongue applicators. For the control without current, the corresponding portions were treated with the respective liquid only. A control without liquid or water, in which the plants were treated with electricity only (dry), was also included. Four different tractor travel speeds, 0.5 km/h, 1 km/h, 2 km/h, and 4 km/h, were used for the current treatment, resulting in four different nominal electrical current inputs (see section Energy Input and Tractor Speed). The liquid application rate for applying the different liquids was 400 l/ha.

Completely untreated strips of the experimental field stretched the entire length of the experimental field as a control (untreated; also referred to as zero control), parallel to the treated lanes or strips.

Liquids (media lowering the electrical transition resistance):

The additives used for the liquids Cocktail, Hasten, Polyaktiv and Bolero are commercially available products. The names of the additives essentially correspond to the proper names of the commercial products. For each of the liquids, the additives were used in water at the concentration specified by the manufacturer.

Cocktail (manufacturer Lotus Agrar GmbH, Stade, Germany) is marketed as an additive for herbicides. Cocktail is a mixture of 60% ethyl oleate from sunflower oil and 40% sugar derivatives.

Hasten (manufacturer ADAMA Deutschland GmbH, Cologne, Germany) is a mixture of rapeseed oil ethyl esters and rapeseed oil methyl esters and nonionic surfactants (716 g/l rapeseed oil ethyl and methyl esters, 179 g/l nonionic surfactants). Hasten is formulated as an emulsion concentrate and marketed as an additive for herbicide treatment.

Polyaktiv is the commercial product Lotus Polyactiv Zn (manufacturer Lotus Agrar GmbH, Stade, Germany), which is on the market as an additive for foliar fertilizers. Polyactive has 10.8% (150 g/l) zinc and 13.5% (185 g/l) sulfuric anhydride (SO3). More important in the present case, however, is the formulation of Polyaktiv, which is made with polyols (also called sugar alcohols). Polyactive is a polyol-zinc complex.

Bolero (SDP Bolero, manufacturer Lotus Agrar GmbH, Stade, Germany) is marketed as an additive for foliar fertilizers. Bolero has 9.5% (120 g/l) boron. More important in the present case, however, is the formulation of Bolero, which is made with polyols (also called sugar alcohols). Bolero is a polyol-boron complex.

The liquid application rate of 400 l/ha for wheat after ear emergence was determined in a preliminary trial in which volumes between 200 and 800 l/ha were tested. Here it was shown that from an application volume of 400 l/ha, the electrical resistance (corresponding to 1 bar for the type of nozzle used) leveled off at approximately 7000-8000 ohms and compared strongly with the strongly fluctuating 12000-22000 ohms when the plants were treated in dry condition.

Energy Input and Speed of the Tractor:

The energy input is also referred to here as energy usage. In addition to the total power available, the real energy usage also depends considerably on the current resistance of the plants and, if applicable, also of the ground, since the voltage supply units can only operate at full power between 2000 and 5000 V. Accordingly, real energy usage per hectare at high resistance can be significantly lower than nominal energy usage calculated at full power.

Depending on the speed of the tractor, the following nominal inputs of electrical energy per hectare are obtained when using the long applicators in grain:

0.5 km/h: 30 kW/ha

1 km/h: 60 kW/ha

2 km/h: 120 kW/ha

4 km/h: 240 kW/ha

Objectives of the Experiment:

The experiment served to compare a treatment by means of the method according to the invention (crop.zone treatment) with a treatment only with electricity (i.e., without liquid) as well as with a treatment only with liquid (i.e., without electricity).

The experiment further served to compare different fluids, each at different nominal inputs of electrical energy (different speeds of the tractor).

Experimental Evaluation:

Only the areas not flattened by the tractor's tires up to a maximum of 30 cm from the outer edges of the working width were used for the experimental evaluation.

The results of the treatment were visually bonitted and plotted by a drone with NDVI measurement one week after treatment. NDVI stands for Normalized Difference Vegetation Index. It is the most commonly used vegetation index. Similar bonitures were grouped into NDVI classes (green value classes). An increase in NDVI class, which was set 1 for the untreated control, corresponds to a decrease in green value.

### Experimental Results

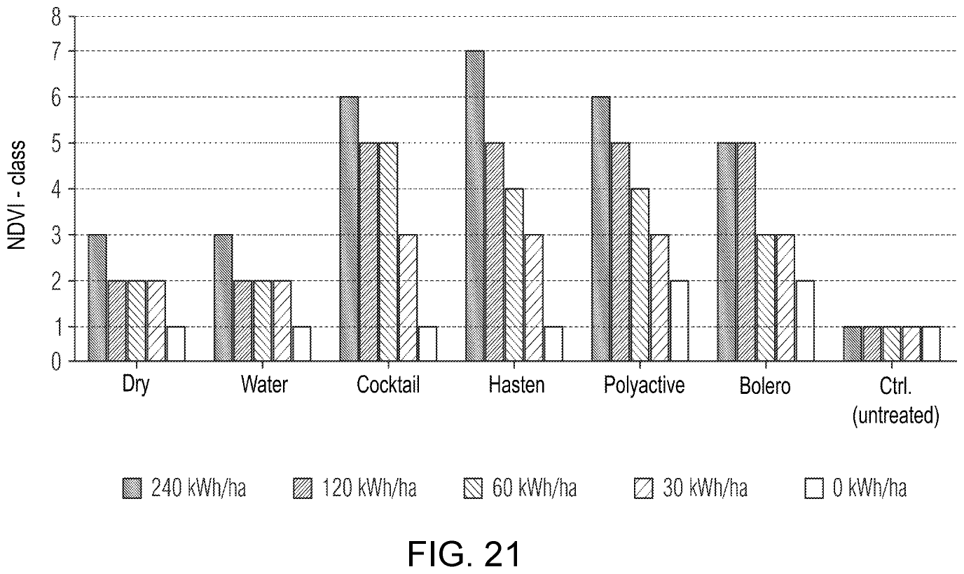

FIG. 21 shows the classification of the NDVI reflections of the drone images of the crop field into seven intensity classes, wherein class 1 corresponds to the highest green value and class 7 corresponds to the lowest green value. NDVI class 1 was set for the untreated control. The figure shows the results of treating the plants with water or different liquids (water with the addition of Cocktail, Hasten, Polyactive or Bolero) and then with electricity. In addition, the results of the following controls or comparative treatments are shown: (1) “Ctrl. (untreated)” is the untreated control; (2) “Dry” is the control without liquid (electricity only); (3) plots each with 0 kWh/ha are the controls without electricity (water or liquid only). The specific energy data represent the nominal input of electrical energy per hectare. The real input of energy may be lower if the resistance does not allow the high voltage units to operate at full load.

The liquids used (water with additives as indicated) have no herbicidal effect themselves. They are designed to enhance the effect of chemicals on plants. Chemical action refers to the action of crop protection agents, such as herbicides, and foliar fertilizers, which are designed to better penetrate plants and then either kill them or fertilize them. In contrast, electricity does not have chemical compounds that could penetrate plants. The liquids used therefore originate from a different field of application and were actually only intended by the inventors for initial screening for more complex electrical transition resistance-lowering media. That the liquids used would show such a large synergistic effect in combination with the application of electricity was in no way expected, since the mechanism of action of electrophysical treatment of plants with electricity is fundamentally different from the mechanism of chemical treatments with crop protection agents and foliar fertilizers.

The results show that, except for the extremely high value of 240 kWh/ha, the treatment of the plants with electricity in dry condition and with previous treatment with water differed from the untreated control by only one green value class and no bonitable differences were discernible among themselves. The reduction in green value at 240 kWh/ha for treatment with electricity in dry condition and with previous treatment with water is equal to that of all treatments with the different liquids at 30 kWh/ha. This means that the biological effect becomes 8 times more efficient by using the liquids.

The results show that treatment with the liquid only, i.e., without electricity (0 kWh/ha), had no effect on the green value of the cereal plants in the case of Cocktail and Hasten as additives. In the case of Polyaktiv and Bolero as additives, a minor effect (increase by one green value class) was observed. With the additional treatment with current, a decrease in the green value occurred in all liquids, in a dose-dependent manner: An increase in the amount of energy used showed an increase in the effect dependent on the dose of the amount of energy used. Thus, there is a dose-response relationship.

Treatment only with electricity, i.e., without liquid or water, showed only a small effect with regard to the reduction of the green value (control “dry”, increase only by one green value class or at 240 kWh/ha by two green value classes). Based on the “dry” control, it can be seen that grains are a challenging application for siccation treatments due to their robustness. Treatment with electricity only corresponds to the prior art. In this case, very high amounts of energy (240 kWh/ha and more) are required to achieve an effect, which is practically unfeasible given the tractor power available electrically in the fields.

The effect obtained with treatment only with electricity at 240 kWh/ha (control “dry”) is surprisingly achieved with the additional use of the liquid (cocktail, Hasten as an additive) already at 30 kWh/ha (achieving green value class 3). Thus, by combining it with the liquid, only one-eighth of the amount of energy is required for the same effect compared to the current treatment alone. This allowed the tractor to travel at 4 km/h for the same effect with the combination of liquid and current, while it had to travel at 0.5 km/h for this with the control without liquid. The reduction in the amount of energy required by a factor of 8 through the combination of liquid and electricity is far beyond expectations in the field of plant treatment, since an improvement by a factor of 2 is already considered exceptional for purely chemical plant treatments.

The reduction in the amount of energy required by a factor of 8 through the combination of liquid and current means that the treatment is practical to implement given the tractor power available in the fields electrically. In addition, the desired effect can be achieved at a higher speed of the tractor, so that the time required to treat the plants is reduced.

However, the combination of the treatment with the liquid and the treatment with the current not only significantly reduced the energy requirement, but surprisingly also significantly increased the effect on the plants, up to the green value class 6, or even up to the green value class 7 in the case of Hasten. Thus, the combination significantly increased the efficiency of the treatment.

The liquids have surface active and wax layer softening ingredients. Hasten showed the best effect as an additive, followed by Cocktail and Polyaktiv. The increase in efficiency demonstrates the importance of wetting and softening the blade surface for electrical current penetration.

Treating the plants with water instead of a medium lowering the electrical transition resistance before current application showed no effect compared to treatment with current only (same result for “water” and “dry”).

The measurements of current and voltage have shown that by using the liquids compared to the treatment in dry condition, the voltage can be reduced from 3600 to 2800 V on average for the same power. This corresponds to a reduction of the electrical resistance by approximately 20%. Further optimization of the liquids is expected to result in further voltage reductions. Low resistances and voltages are also critical for cost-effective production of the application apparatus and effective safety configuration of the same. Furthermore, the effect of the electrical current increases with decreasing resistance or increasing currents for the same total amount of energy.

The results show that the transition resistance between the applicator and the plant can be reduced by about 20% after a very short exposure time (about 4-8 s) by using media that lower the electrical transition resistance, especially wax layer softening and wetting liquids. However, the biological effects of current application increase up to 8-fold for the same (low) effect level if a medium that lowers the electrical transition resistance is used instead of using pure water or treating the plants in a dry state. Without such a medium, no relevant siccation of grain could be achieved even at very high energy intensities (240 kWh/ha) when using pure water or treating the plants in dry condition. However, after addition of the medium, which itself has no herbicidal effect, massive chlorophyll loss and incipient siccation could be observed.

The results show that, in terms of treating the plants with electricity, the use of a medium that lowers the electrical transition resistance is the decisive effect compared to the use of pure water or treating the plants in a dry state. What has been shown here using the example of grains can easily be applied to a wide variety of other plants.

### Experiment 2: Treatment of Potatoes

Properties of the Experimental Field:

The field is located at Peringsmaar/Bedburg in North Rhine-Westphalia, Germany (50° 59′37.5″N 6° 35′21.0″E). The surface is a recultivation surface of the lignite open-cast mine there. Accordingly, the ground type is described as application pararendzina. According to the mapping instructions of the Geological Service of North Rhine-Westphalia, the ground is silty loam. The recultivation was about 15 years ago. Nevertheless, the ground stands out for its very low microbial degradation activity, for example for grain straw. However, for potatoes the ground offers exceptionally good growing conditions compared to nearby grown ground. Despite the hot and dry summer, the field used was the only non-irrigated potato field in the region that was still completely green at the time of siccation. The estimate of the value figure is high at 45-75.

### Experimental Design

A vehicle, namely a tractor with hoe tires, with an apparatus according to the invention was used for the treatment of potatoes. A spraying device (field sprayer) with a working width of 6 m was attached to the front of the tractor as an application device. The spraying device could be parked halfway depending on the experimental target, resulting in experimental plots 3 m wide and 10 m long. The spraying of liquid was done about 10 m before the application of current. For applying the current, an application device for applying current was mounted at the rear of the tractor. In this case, the power generator was driven by the PTO shaft and had an output of up to 72 kW. 20 high-voltage units, each with 3.6 kW power, provided the nominal power in a voltage range between 2000 and 5000 V. The apparatus worked on 6 m width (working width).

The field was planted with the edible potato variety Challenger (Apr. 14, 2022) and treated conventionally with crop protection measures and fertilizer. At the time of treatment, the potato plants were in phenological stage 81 (81-83), i.e., still vigorously green. The Challenger variety is generally considered to be vigorous and difficult to siccate. The hot and dry summer generally led to an increased formation of wax layers.

The tractor drove between the 3rd/4th and the 5th/6th Dam crown. Only rows 3 and 5 are used for experimental evaluation. Individual experimental plot portions treated at different tractor speeds were separated by holding and acceleration areas. The individual experimental plots were partially randomized, since only such surface arrangements can be traversed at three different speeds using an apparatus with a 6 m working width.

Based on the unexpected success of combining liquid and current in grains (experiment 1), a wetting agent well established in potato (Cantor, HL1) was tested in combination with the application of current, and a conductivity-increasing salt solution was added to the wetting agent as a further variant (HL2). For this purpose, the portions were first treated with the different liquids (HL1, HL2) according to the experimental plan and, after a very short exposure time in the range of a few seconds, with current. For the control without current (liquid control), the corresponding portions were treated with liquid HL2 only. Three different tractor travel speeds, namely 2 km/h, 4 km/h, and 6 km/h, were used for the current treatment, resulting in three different nominal inputs of electrical energy. The liquid application rate for applying the different liquids was 150 l/ha (nHL) for part of the experiments, while it was 300 l/ha (HL) for another part of the experiments and for the liquid control.

Single treatments and double treatments, each with the combination of liquid and current described above, were performed. In the double treatments, the second treatment took place 1 week apart from the first treatment. There was also an experimental part where the second treatment was a pure chemical treatment with Shark (1.0 l/ha) instead of a liquid and current treatment.

The first liquid HL1 used in the experiment was the approved additive Kantor at a concentration of 0.15%, since the potatoes were to go to the open market. Kantor is a commercially available product. The name is the proper name of the commercial product. Kantor is based on an alkoxylated triglyceride technology and is marketed as an additive to safeguard the efficacy of crop protection agents (manufacturer agroplanta GmbH & Co. KG, Zustorf, Germany). Kantor is formulated as a liquid active ingredient concentrate and acts as a wetting agent. In addition to alkoxylated triglycerides, Cantor has 1-10% acetic acid and 1-10% D-glucopyranose, oligomers, decyloctylglycosides. For the second liquid HL2, magnesium sulfate (magnesium sulfate heptahydrate, also known as epsomite, MgSO4*7H2O, manufacturer e.g., K+S KALI GmbH, Kassel, Germany) was added to HL1 at a concentration of 1 kg/100 L of liquid.

Completely untreated experimental plots were included as controls (untreated; also referred to as zero controls). As a further control, a purely chemical treatment of the plants (Quick/Shark; also referred to as Quickdown/Shark or as a positive control), that is, without liquid HL and without electricity, was included. The purely chemical treatment (siccation) was performed with Quickdown 0.8 l/ha+Toil 2.0 l/ha and seven days later, i.e., one week apart, with Shark 1.0 l/ha (Quickdown: 24.2 g/l pyraflufen (wt. % 2.4), Belchim Crop Protection Deutschland GmbH, Burgdorf, Germany; Toil: 10% Coco Diethanolamide, Cheminova Deutschland GmbH & Co. KG, Stade, Germany; Shark: 55.92 g/l Carfentrazone (60 g/l ethyl ester), Belchim Crop Protection Deutschland GmbH, Burgdorf, Germany). The names are the proper names of the commercial products. The application rates of the substances and water correspond to the professional standard treatment for chemical potato siccation and were determined and performed in this manner by an expert in potato siccation from the Rhineland Chamber of Agriculture.

The experiments with the different liquids took place on three lanes next to each other. Only the purely chemical control treatments and zero control were located on an additional fourth lane, which was directly adjacent to the third lane.

Due to space and expense constraints, only two replicates could be performed per treatment. A total of 41 experimental links (different plot treatments) were made in two replicates.

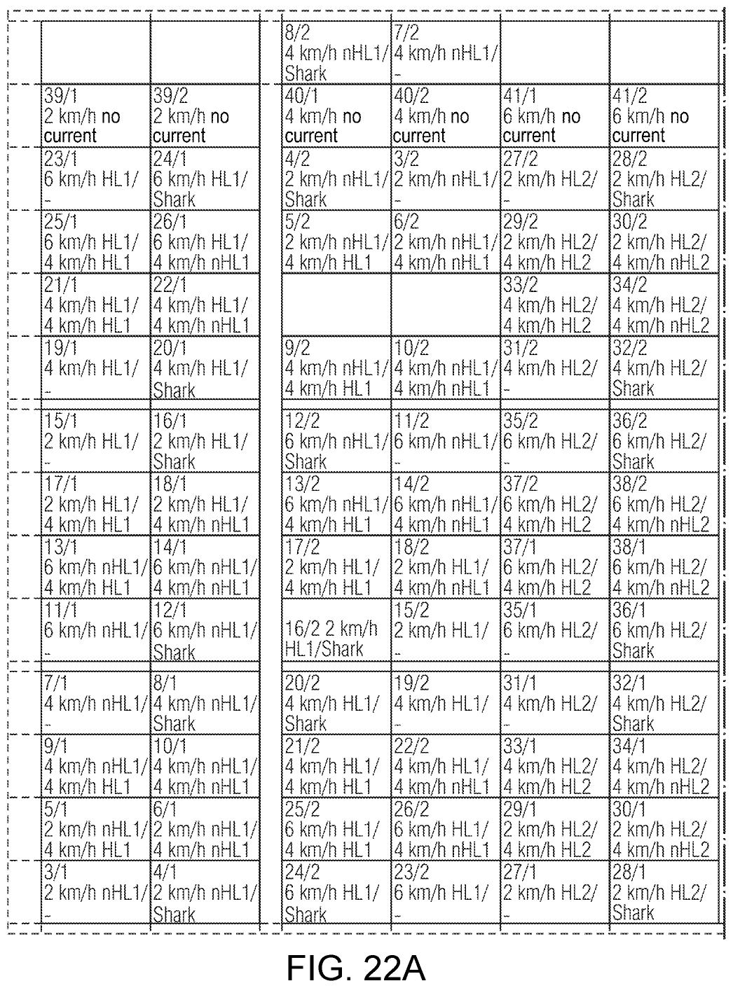

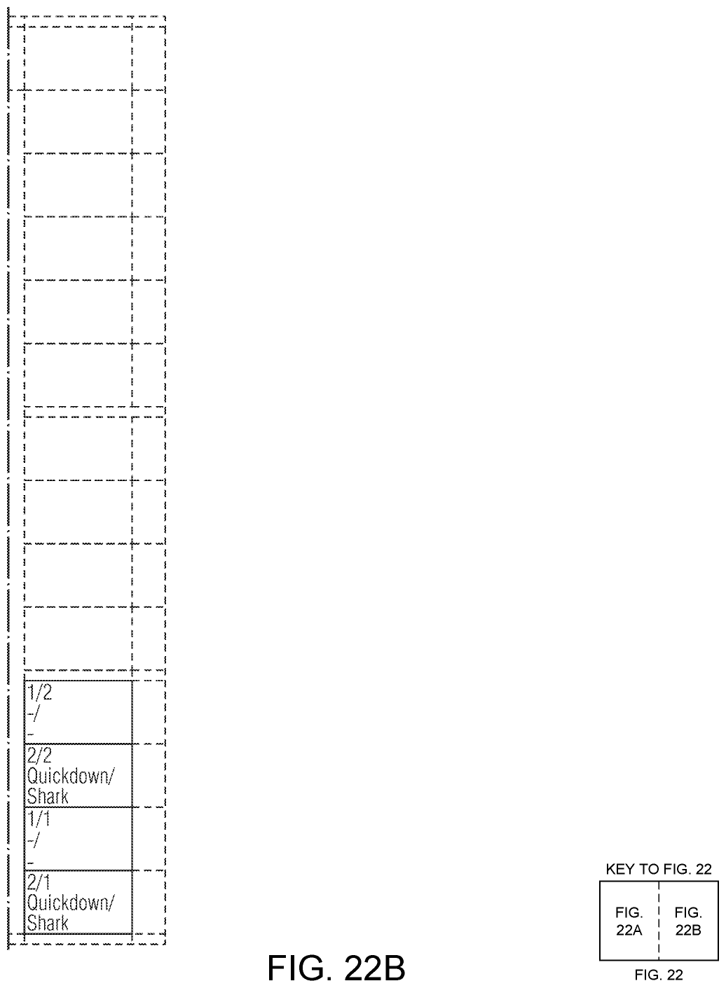

FIGS. 22A and 22B show the experimental arrangement, i.e., the arrangement of the experimental links in the field. The plot size was 3×10 m. HL1 and HL2 denote the different liquids. nHL stands for the low liquid application rate of 150 l/ha and HL for the high liquid application rate of 300 l/ha. Two treatments were performed 1 week apart (first treatment/second treatment), wherein the second treatment could also be a purely chemical treatment (Shark) or, in the case of a single treatment, omitted (−). The chemical-only control treatments (Quickdown/Shark) were on an additional strip on which the untreated controls (−/−) were also located.

Energy Input and Speed of the Tractor:

The energy input is also referred to here as energy usage. In addition to the total power available, the real energy usage also depends considerably on the current resistance of the plants and, if applicable, also of the ground, since the voltage supply units can only operate at full power between 2000 and 5000 V. Accordingly, real energy usage per hectare at high resistance can be significantly lower than nominal energy usage calculated at full power. Real energy usage may be lower, especially for the second crossing, which occurred one week after the first crossing, when the resistance of the partially dried plants is so high that the power supply can no longer operate in the full load (2500-5000 V) working range. Accordingly, the speed is referred to in the description of the experiment.

As a function of tractor speed, the following nominal inputs of electrical energy per hectare are obtained when used in potatoes:

2 km/h: 48 kWh/ha

4 km/h:24 kWh/ha

6 km/h:16 kWh/ha

### Objective of the Experiment

The experiment served to compare two different media (liquids) lowering the electrical transition resistance and two different application rates of a liquid, in each case with different nominal inputs of electrical energy (different speeds of the tractor).

### Experimental Evaluation

For experimental evaluation, all plots were photographed individually 1-2 times per week (each dam individually longitudinally 10 m, NIKON D7000 resolution 12 MP). Here, only the data three weeks and 20 days after the first treatment were evaluated. The 3-week period results from the general scheduling scheme of siccation treatments.

The images of the 10 m plots were evaluated visually. In each case, the stems were classified into the color classes gray, yellow and green. The gray color class contains both completely desiccated/brittle stems and those that were so brown and viscous that complete desiccation was only a matter of time with no possibility of resprouting. Yellow stems were not yet completely dead, had no, green or yellow leaves and could also still lead to resprouting. Green stems did not possess, yellow or green leaves. In the experimental parts where resprouting was bonitized separately, it consisted of small leaves (max. 2 cm in size) emerging directly from the stems. An average of 81 stems per plot was evaluated, totaling 6643 potato stems.

### Experimental Results

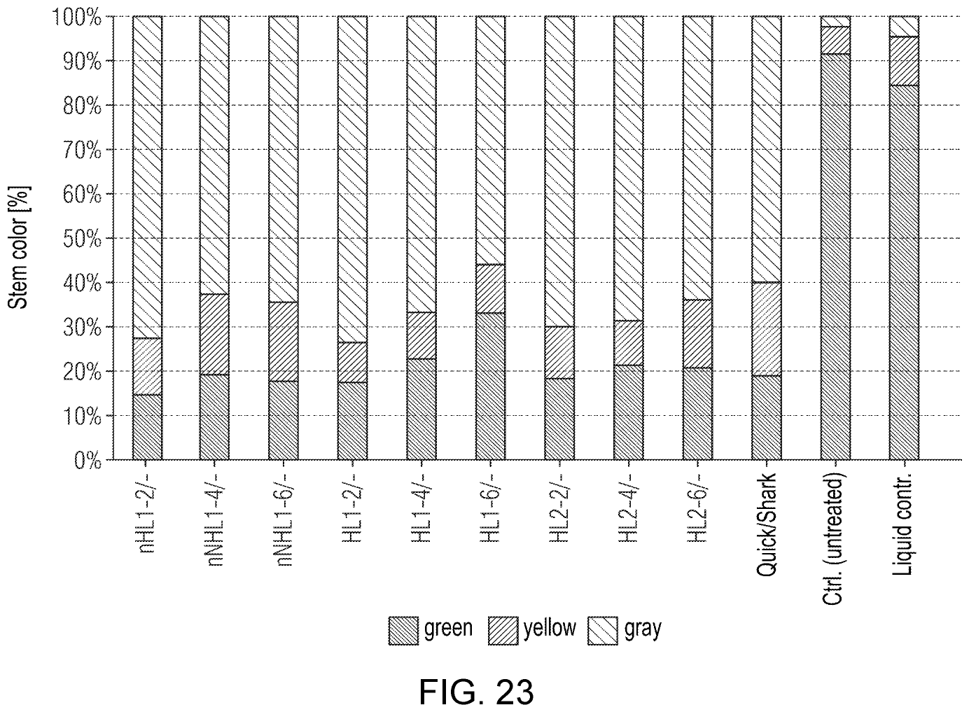

FIG. 23 shows the results of individual treatment of potatoes with liquid HL1 or HL2 and with current. The figure shows the percentage of green, yellow and gray stems 20 days after the first crop.zone treatment. In the crop.zone treatment, the field portions were first treated with the liquid HL1 or HL2 and, after a very short exposure time in the range of a few seconds, with current. Compared the liquids HL1 and HL2 at low (nHL) and high (HL) usage rates (liquid application rate) with single application of crop.zone treatment at different speeds (2, 4, and 6 km/h, labeled −2, −4, and −6, respectively, in the designation) in comparison to positive control (Quick/Shark), control without treatment (untreated), and liquid control (liquid contr.).

Interestingly, the use of a higher nominal energy per ha at 2 km/h (48 kWh/ha) showed only slightly better desiccation than 16 kWh/ha (6 km/h) regardless of the liquid used. The highest efficacy was found at 2 km/h for low volume (nHL1) and high volume including conductivity component (HL2). The best average effectiveness for all speeds was achieved with HL2. Accordingly, the use of an electrically conductive component in the liquid is advantageous.

Also, the pure chemical double treatment (Quick/Shark) was not more effective than the single crop.zone treatment. The observed limited efficiency of the purely chemical treatment despite the optimal weather for the substances in the experimental period (a lot of sun and dryness) corresponds to the gap in effectiveness that occurred after the ban of Reglone (Diquat) or after its approval ended due to toxicity against so-called “bystanders”. This gap in effectiveness is an important reason for the need for the method according to the invention.

The simple crop.zone treatment on green plants of hard-to-siccify potato varieties such as Challenger at higher speed (6 km/h with only 16 kWh/ha of electrical energy) with HL2 results in effective canopy opening (replaces Reglone): For a better siccation result, the crop.zone treatment can be integrated into a two-step siccation. A two-stage siccation treatment also corresponds to the usual chemical double treatment and the associated gentle, gradual initiation of the ripening process of such potato varieties.

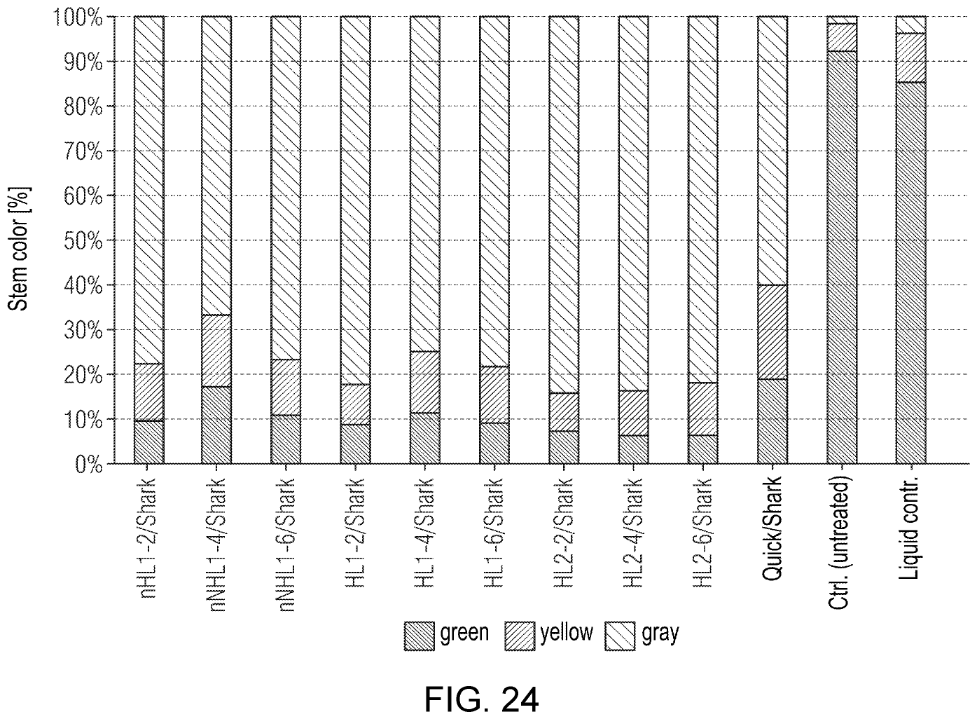

FIG. 24 shows the results of single treatment with liquid HL1 or HL2 and with current in combination with chemical secondary treatment. The figure shows the percentage of green, yellow and gray stems 20 days after the first crop.zone treatment. In the crop.zone treatment, the field portions were first treated with the liquid HL1 or HL2 and, after a very short exposure time in the range of a few seconds, with current. The liquids HL1 and HL2 are compared at low (nHL) and high (HL) usage rates (liquid application rate) with a single application of the crop.zone treatment at different speeds (2, 4, and 6 km/h, labeled −2, −4, and −6, respectively, in the designation) in combination with Shark as a chemical secondary treatment (reapplication) in comparison with the positive control (Quick/Shark), the control without treatment (untreated), and the liquid control (liquid contr.).

The results show that the stems were dried out (grayed) about 10-20% better in the case of the chemical secondary treatment than after a single treatment (FIG. 23). Both treatments with HL1 (low and high volume of liquid) show their lowest efficacy at 4 km/h for unknown reasons but reproducibly, while HL2 at high volume (low volume not tested) shows the highest and almost constant efficacy (highest amount of gray stems) at all three speeds.

Compared to the purely chemical positive control (Quick/Shark), the efficacy of the crop.zone treatment was about 30% higher. This underlines the high efficacy of the crop.zone treatment compared to Quickdown, which replaces Reglone especially in the siccation of still completely green potatoes. The crop.zone treatment is significantly more efficient than Quickdown as an initial treatment. The crop.zone treatment at higher speed (6 km/h, 16 kWh/ha) using a well conducting liquid in combination with a secondary treatment with Shark already resulted in an effective siccation better than the pure chemical double treatment (Quick/Shark).

Visual boning revealed that the remaining green stems and the majority of the yellow stems had an orientation across the direction of travel and reached primarily down into the valleys between the dams. Accordingly, the accessibility by the applicators is the reason for the residual stock of non-dried stems.

A third treatment or later timing of the second treatment may be beneficial to completely dry out the stems and minimize regrowth, especially if the potatoes were still completely green during the first treatment.

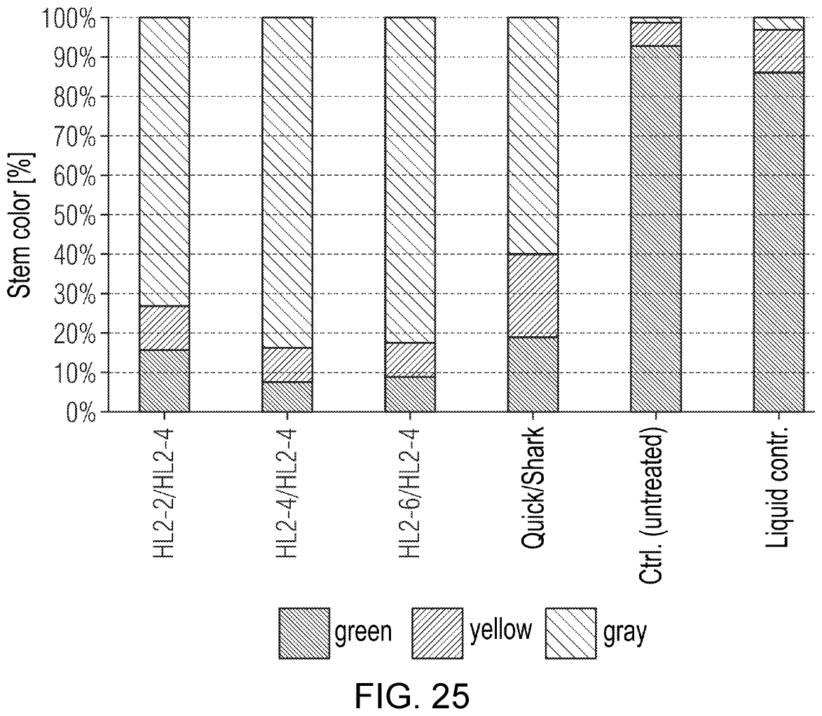

FIG. 25 shows the results of the double treatment, both with liquid HL2 and with current. The figure shows the percentage of green, yellow and gray stems 20 days after the first crop.zone treatment. In the crop.zone treatment, the field portions were first treated with the liquid HL2 and, after a very short exposure time in the range of a few seconds, with current. Compared the different speeds (2, 4 and 6 km/h, labeled −2, −4 and −6, respectively, in the designation) in the first treatment and a constant speed of 4 km/h in the second treatment in comparison to the positive control (Quick/Shark), the control without treatment (untreated) and the liquid control (liquid contr.).

The results show that the double crop.zone treatment dried out (grayed) the stems about 10% better than after a single crop.zone treatment.

Interestingly, the use of a higher nominal energy per ha at 2 km/h (HL2-2, 48 kWh/ha) did not show better desiccation than the use of 16 kWh/ha (HL2-6). A higher speed (6 km/h) instead of 2 km/h did not reduce the effectiveness.

As a result, the crop.zone treatment resulted in effective siccation even at high speed (6 km/h) of the initial treatment in combination with a second crop.zone treatment. Thus, the crop.zone treatment provides a completely non-chemical treatment to enable high quality and targeted organic potato production.

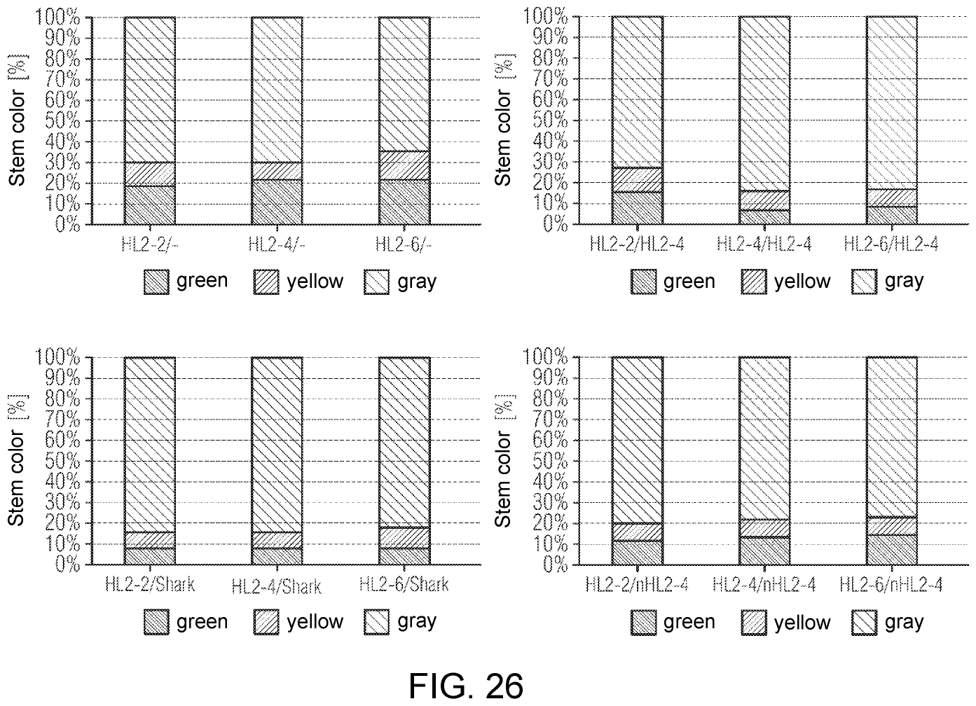

FIG. 26 shows the results of four different treatment patterns. The figure shows the percentage of green, yellow and gray stems 20 days after the first crop.zone treatment. In the crop.zone treatment, the field portions were first treated with the liquid HL2 and, after a very short exposure time in the range of a few seconds, with current. Compared are the different velocities (2, 4, and 6 km/h, labeled −2, −4, and −6, respectively, in the designation) at initial treatment for the four different treatment patterns. Top left: single crop.zone treatment with HL2. Top right: double crop.zone treatment with HL2 and constant 4 km/h in secondary treatment with high liquid application rate. Bottom left: crop.zone treatment with HL2 in combination with Shark as secondary treatment. Bottom right: double crop.zone treatment with HL2 and constant 4 km/h in secondary treatment with low liquid application rate. Since this presentation of results is only concerned with the small dependence of the siccation on the speed or the amount of energy used (factor 3, difference between 2 km/h and 6 km/h), controls were omitted here.

Despite halving the energy from 2 km/h to 4 km/h, only two treatments with low volume of liquid (nHL2) show slightly lower efficacy at 4 km/h in the second treatment, while high volume of liquid even shows higher efficacy. 6 km/h showed either no reduction in efficacy (double treatment with high volume) or only a slight reduction of maximum 5% in the other treatments.

In summary, the crop.zone treatment has a high potential for higher speeds (6 km/h and more) and lower energy to achieve adequate drying effects. This is true regardless of how the second treatment is implemented (crop.zone or chemical) after the physiologically important opening of the leaf roof in the first treatment step.

Overall, the results of experiment 2 show that the addition of conductivity-increasing components such as magnesium sulfate to a wetting agent leads to a further improvement in siccation. By using the wetting agent and magnesium sulfate in the medium lowering the electrical transition resistance, the more constant and better results were obtained with a lower rate dependence of the effect of the medium.

The combination of treatment with a medium that lowers the electrical transition resistance and treatment with current enables a significant reduction in energy consumption compared to treatment with current alone. This is a crucial breakthrough technologically, as the electrical power available to tractors, especially when using narrow hoe tires in potato fields, is significantly limited, and even when using tramlines, more than 120 kW of current is rarely available. Accordingly, only an application rate in the area of 30-50 kWh/ha allows a sufficient working width of the equipment (currently 6 m, in the future 12 m or more) and an agronomically reasonable surface performance of approximately 6-9 ha/h at a speed in the range of 6-8 km/h.

In comparison, haulm toppers (experiment 3) generally operate at speeds of 8-12 km/h at 3 m working width, resulting in surface performances of 2.4-3.6 ha/h and energy quantities in the range of about 8-14 kWh/ha.

In the experiment in grain (experiment 1), a dose-response relationship of the crop.zone treatment was observed as a function of the amount of energy (dose) introduced. In contrast, in the experiments in potatoes, only a small dose dependence of the siccation (dependence of the siccation on the speed or the amount of energy applied) of the crop.zone treatment was observed. This was because the inventors did not sufficiently lower the amount of energy used for this purpose in the potato experiments (i.e., they did not test higher speeds of the tractor, such as 8 or 10 km/h). The reason is that the inventors did not expect such pronounced siccation effects to appear visibly after three weeks even at a speed of 6 km/h.

### Experiment 3: Treatment of Potatoes in Combination with Haulm Topping

The information on the characteristics of the experimental field, the experimental design, and the energy input and speed of the tractor from experiment 2 also apply to experiment 3, except for some deviations in the experimental design. Only the deviations in the experimental design are described below.

For the experiment, a treatment strip of 300 m length was used on the same field, on each of which approximately 100 m long portions were run at three different speeds and crop.zone treatment using liquid HL2 and a liquid application rate of 300 l/ha. In the crop.zone treatment, the portions were first treated with the liquid HL2 and, after a very short exposure time in the range of a few seconds, with current. Three different travel speeds of the tractor, namely 2 km/h, 4 km/h and 6 km/h, were used for the current treatment, resulting in three different nominal inputs of electrical current (see experiment 2). The haulm topping was done by the farmer with a standard haulm topper with 3 m working width and approximately 10-15 km/h working speed.

For the combined treatment experiment, the treatment strip with different dam application was driven on for the second time each 3 to 4 days apart with the tractor performing the crop.zone treatment (see experiment 2), with a haulm beating (two dams staggered) and again one dam staggered with the tractor performing the crop.zone treatment. This leads to the following four treatment combinations, wherein CZ stands for crop.zone treatment and HT for haulm topping:

CZ/CZ (double treatment with crop.zone),

CZ/HT/CZ (haulm topping between two crop.zone treatments),

CZ/HT (haulm topping after crop.zone treatment), and

HT (haulm topping only).

It additionally leads to an intermediate row that was not itself treated with crop.zone before haulm topping, but whose neighboring row was, and which also received partial treatment because of overhanging culms:

(CZ)/HT (haulm topping after crop.zone partial treatment).

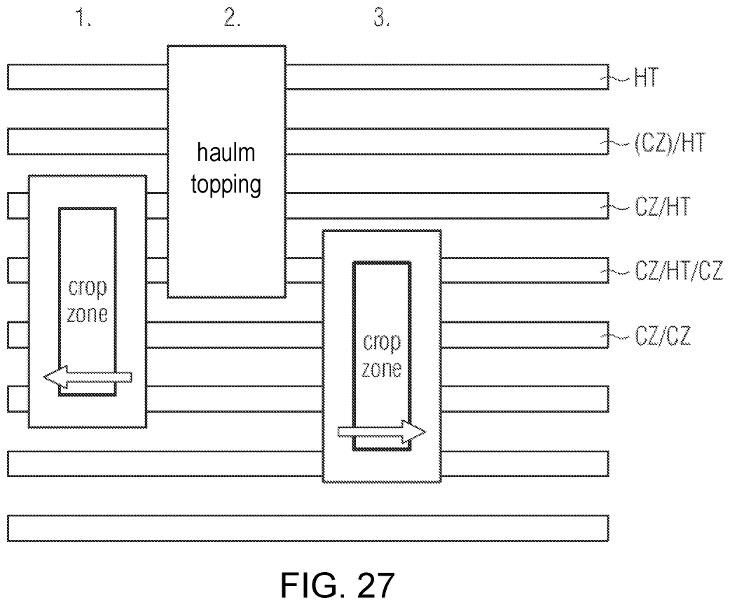

FIG. 27 shows the experimental arrangement just described.

### Objective of the Experiment

The experiment was used to compare four or five different treatment combinations, each at different nominal inputs of electrical energy (different tractor speeds).

### Experimental Evaluation

The experimental evaluation was performed as described for experiment 2. By visually classifying the stems (gray, yellow, green, resprouting (from green or yellow stems)), each of the stems on 20-m-long pieces (211-287 stems per sample, a total of 3807 potato stems) on 15 pieces were evaluated here.

### Experimental Results

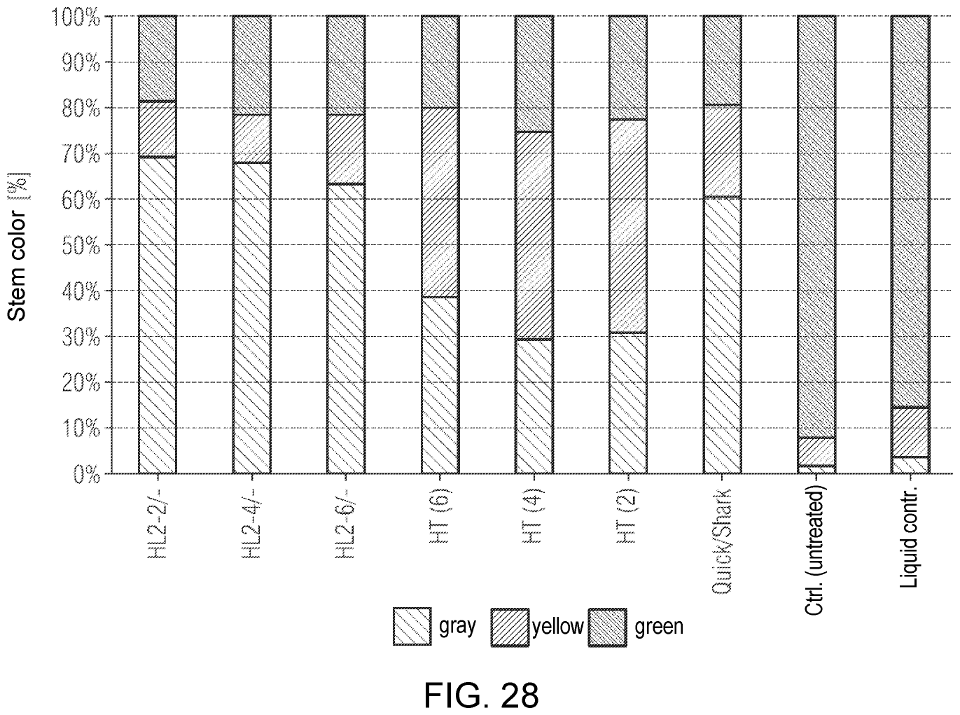

FIG. 28 shows the results of the crop.zone treatment of potatoes compared to haulm topping. The figure shows the percentage of green and restored culms and yellow and gray stems 20 days after the first crop.zone treatment. In the crop.zone treatment (CZ), the field portions were first treated with the liquid HL2 and, after a very short exposure time in the range of a few seconds, with current. Data from the single crop.zone treatment at three different speeds (2, 4, and 6 km/h, labeled −2, −4, and −6, respectively, in the designation) and the haulm strike (HT) alone in three replicates (2, 4, 6) of the positive controls (Quick/Shark), the control without treatment (untreated), and the liquid control (liquid contr.) were compared. Haulm topping alone (HT) was evaluated in parallel with crop.zone treatments in triplicate on potato ridges along a complete field length (300 m), wherein replicates were named analogous to the different speeds only ((2), (4), (6)).

The main difference between haulm topping replicates was the higher percentage of re-sprouting from yellow and green stems (up to 18% in replicate (4)), which are not shown in the graph because re-sprouting was not evaluated separately in the crop.zone treatment.

All single treatments and the pure chemical double treatment showed a remaining number of green stems in the area of 15-25% after three weeks. fter three weeks. While haulm topping never had more than 40% of dried gray stems, the single crop.zone treatment already showed 60-70% gray stems. The pure chemical double treatment showed 19% green stems and 60% gray stems, an effect below the single crop.zone treatment, which is an expression of the limited effect of the remaining chemical siccation agents even in optimal years with plenty of sunshine.

The single treatment with haulm topping or crop.zone was not enough to dry out vigorous green potato plants. Herbaceous batting alone showed the least desiccation of stems even in the fairly dry year of the experiment. Open stem ends after haulm topping and the regrowth triggered by haulm topping even in the fairly dry year pose an additional risk for viral infections from aphids and for other diseases.

Based on these results, crop.zone treatment is more effective than haulm topping for opening the leaf roof. A double treatment with crop.zone without haulm topping or a combination of crop.zone treatment with a chemical secondary treatment is the better choice for vigorous varieties compared to the use of haulm topping.

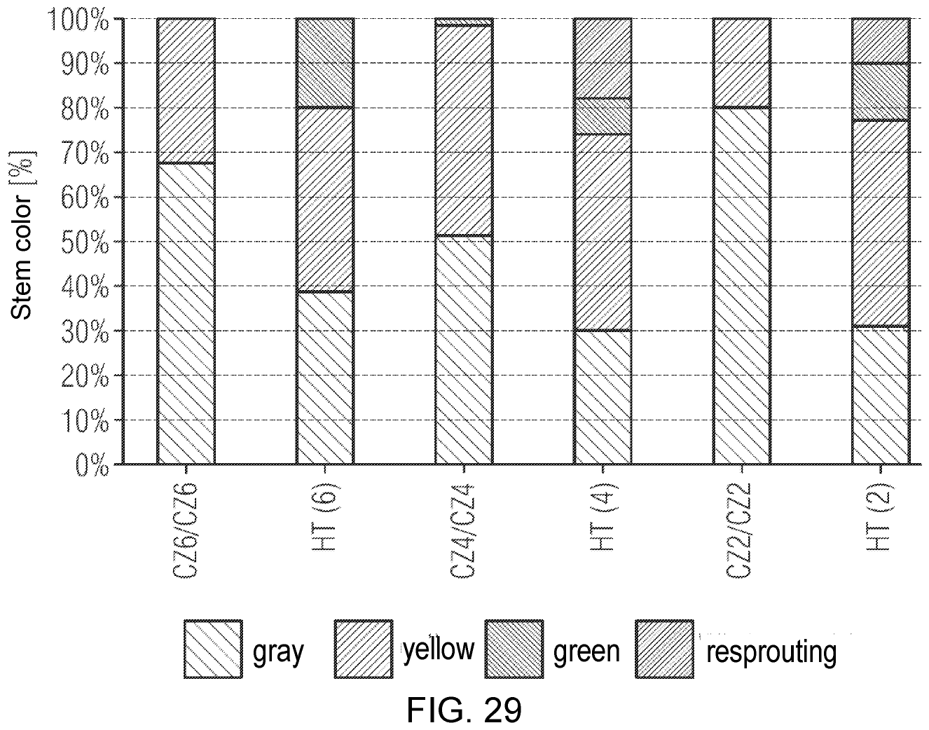

FIG. 29 shows the results of crop.zone double treatment compared to haulm topping. The figure shows the percentage of green and restored (resprouting) culms and yellow and gray stems 20 days after the first crop.zone treatment. In the crop.zone treatment (CZ), the field portions were first treated with the liquid HL2 and, after a very short exposure time in the range of a few seconds, with current. Data from the two crop.zone treatments at three different speeds (2, 4, and 6 km/h, labeled 2, 4, and 6, respectively, in the designation) from experiment 2 (same direction of travel) were compared with data from the haulm strike (HT) experiment (crop.zone treatment in opposite direction of travel).

While in one series of experiments the direction of travel of the second treatment was opposite to the first treatment, in the other series of experiments the direction of travel was in the same direction as the first treatment. While in the experiment with the opposite direction of travel the speed for the first and the second travel was always similar (2, 4 or 6 km/h), in the experiment with the same direction of travel only the speed for the first travel varied and the second travel was always at 4 km/h.

The percentage of gray stems was higher or similar for the same direction of travel (more double treatment of the same stems) compared to travel in the opposite direction. In contrast, the opposite direction of travel showed almost no remaining green or regrowth stems, as all stems were electrically flushed at least once. This resulted in a dosage distribution that only at 2 km/h (the highest energy level, 48 kWh/ha) results in sufficient dosage to cause about 80% of the stems to turn gray. At higher speeds, more yellow stems remained, which had not yet completely dried out during the experimental period, but were also not relevantly resprouting. The highest percentage of yellow stems at 4 km/h is attributed to the fact that the ground or microclimate conditions in the center of the field provided even more water here, resulting in slower drying. The phenomenon was observed to be even more pronounced in the haulm-only experiment along the entire length of the field.

As a result, it can be stated that safe contact of as many stems as possible by the application apparatus is important even with the additional use of liquids, and that an opposite approach during secondary treatment further improves the siccation success.

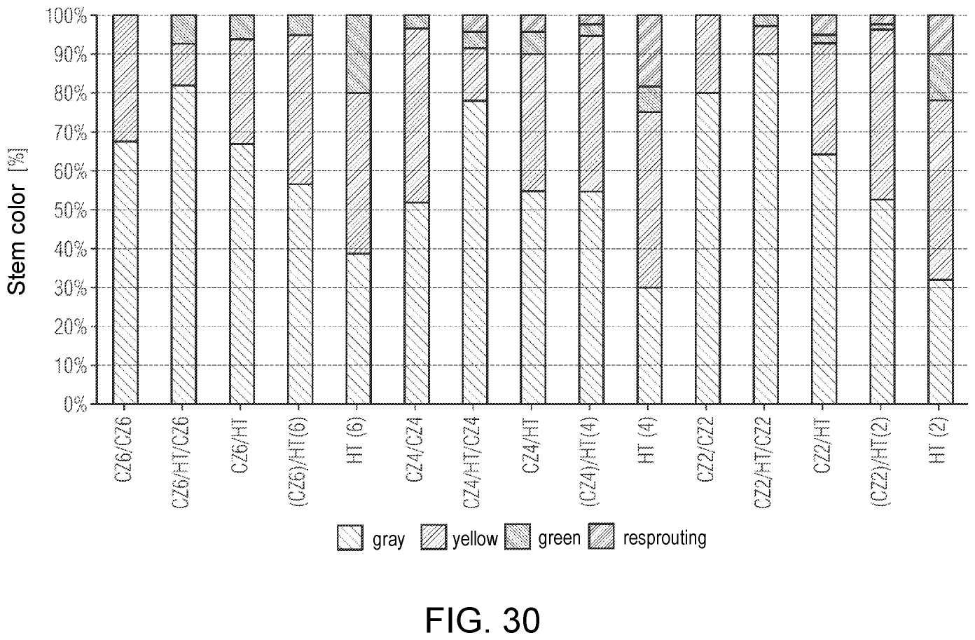

FIG. 30 shows the results of crop.zone treatment of potatoes in combination with haulm topping. The figure shows the percentage of green, yellow and gray stems and resprouting as green or yellow culms (resprouting) 20 days after the first crop.zone treatment. The arrangement of the bars within the speed groups corresponds to the spatial arrangement in the field: crop.zone treatment with 6 km/h (left columns), 4 km/h (middle columns) and 2 km/h (right columns). Meaning of the abbreviations: CZ=crop.zone treatment, (CZ)=secondary lane partially treated by crop.zone because of potato plant projection, HT=haulm beating as standard method (number only as positional designation of adjacent area). Double treatment with crop.zone (CZ/CZ) represents the best compromise between high percentage of gray stems and at the same time minimizing resprouting.

The combination of double crop.zone treatment with intervening haulm topping (CZ/HT/CZ) yielded the highest percentage of gray stems at all speeds. At the same time, haulm topping in any combination of methods left a significant amount of green stems and resulted in resprouting on up to 18% of stems depending on soil moisture or other soil-related factors. Even the double crop.zone treatment with interspersed haulm topping did not completely prevent rash reappearance, although this is critical for viral infections caused by aphids. A combination of single crop.zone treatment followed by haulm topping (CZ/HT) resulted in more green residual leaves and resprouting than a double crop.zone treatment at all speeds. Interesting in the experiment is the influence of crop.zone treatment on neighboring rows. As the potato plants spread widely into the neighboring row, even in the haulm topped only row ((CZ)/HT) next to the crop.zone treated row (CZ/HT), an effect is seen at all travel speeds that is well above the effect of haulm topping alone.

Overall, the results of experiment 3 show that even in a dry year, a double crop.zone treatment (CZ/CZ) is the most effective siccation method compared to haulm topping and compared to combinations of the two methods, achieving a relatively high percentage of gray stems while minimizing the particularly undesirable resprouting. Driving at 6 km/h with a nominal 16 kWh/h each guarantees high surface performance and low energy consumption.

Haulm topping does not result in any relevant siccation benefits and only appears to be useful if the farmer wants to reduce the starch content of the potatoes through reseeding. For more humid years, even greater resprouting can be expected, which may result in significant secondary chemical treatments after haulm topping (including insecticide treatments) or may also require tertiary crop.zone or chemical tertiary treatments.

The additional haulm topping (CZ7HT/CZ), which ranks 2nd, can furthermore produce much more green potatoes, as the working width rarely exceeds 3 m and accordingly many dams are damaged or potatoes are also superficially exposed (crop.zone 6 m or in the future 12 m or more). Short-cut stems are an additional source of viral and fungal infection occurrence, and further chemical treatment may be needed to minimize these risks.

### REFERENCE NUMERALS

1 apparatus
10 first module
11 nozzle
11a spray nozzle
11b sheath nozzle
11c aspirated gases
12 scraper
121 scraper segment
122 sub-segment
13 first support structure
14 liquid container
15 transition resistance-reducing medium
16 sensors
161 optical sensors
162 movement sensors
17 non-selective herbicides
18 dosing element
20 second module
21 electric applicator
211 applicator segment
212 unheated contact segment for small plants
22 first applicator row
23 second applicator row
24 second support structure
25 support wheel
26 safety cover
27 holder
29 hinge
30 carrier vehicle
31 PTO shaft
32 generator
33 transformation and control unit
34 leading device
35 trailing device
36 exhaust gas line pipe
40 plant
41 leaf
42 root
43 stem
44 ground
51 wire
52 foam
53 star wheel applicator
60 applicator end pieces
61 grounding disk
62 measuring equipment
70 protective disk
71 insulating protective disk
72 bristles

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

1-21. (canceled)

22. An apparatus for applying electrical current to plants comprising:
an application device adapted to apply an electrical transition resistance-reducing liquid to plants, wherein the application device is connected to a heat source; and
an electrical applicator adapted to apply an electrical current to the plants.

23. The apparatus of claim 22, wherein the application device is adapted to dose the electrical transition resistance-reducing liquid.

24. The apparatus of claim 22, wherein the application device includes a nozzle.

25. The apparatus of claim 24, wherein the nozzle is a sheath nozzle.

26. The apparatus of claim 22, wherein the application device is adapted to apply the electrical transition resistance-reducing liquid to the plants from multiple angles.

27. The apparatus of claim 22, wherein the application device is adapted to hang down and to scrape the plants.

28. The apparatus of claim 22, wherein the application device is coupled to a high voltage source.

29. The apparatus of claim 22, wherein the application device is adapted to apply the electrical transition resistance-reducing liquid to the plants indirectly via the electrical applicator such that the electrical transition resistance-reducing liquid is first applied to the electrical applicator.

30. The apparatus of claim 22, wherein the electrical applicator is connected to a source of heat.

31. The apparatus of claim 22, further comprising:
a sensor selected from the group consisting of: an optical sensor, a lidar sensor, a height sensor, a movement sensor, a thermal sensor, a electrical current sensor, and a mechanical stress sensor.

32. The apparatus of claim 31, wherein the sensor measures a characteristic of the electrical applicator.

33. The apparatus of claim 22, further comprising:
an end piece attached at a lower distal end of the electrical applicator, and wherein the end piece is less electrically conductive than is the electrical applicator.

34. The apparatus of claim 22, wherein the electrical applicator is adapted to hang down and to be pulled in a direction of travel over the plants, and wherein the electrical applicator is also adapted to move transversely to the direction of travel.

35. The apparatus of claim 22, further comprising:
a protective disk that is made of metal; and
a non-conductive disk, wherein the protective disk and the non-conductive disk are oriented parallel to one another.

36. A method of applying electrical current to plants, comprising:
heating an electrical transition resistance-reducing liquid;
applying the heated electrical transition resistance-reducing liquid to plants; and
applying an electrical current to the plants to which the electrical transition resistance-reducing liquid has been applied.

37. The method of claim 36, wherein the electrical current is applied to the plants using an electrical applicator, further comprising:
heating the electrical applicator before the electrical current is applied to the plants.

38. The method of claim 36, wherein the electrical transition resistance-reducing liquid is selected from the group consisting of: an aqueous liquid, an oil, a viscous liquid, a highly concentrated solution, a thixotropic liquid, a suspension, an emulsion, and a foam.

39. The method of claim 36, wherein the electrical transition resistance-reducing liquid is applied to the plants in an amount based on an electrical conductivity of the plants.

40. The method of claim 36, further comprising:
electrically charging the electrical transition resistance-reducing liquid before applying the electrical transition resistance-reducing liquid to the plants.

41. The method of claim 36, further comprising:
mechanically preconditioning the plants before applying the electrical transition resistance-reducing liquid to the plants, wherein the preconditioning is selected from the group consisting of: mowing, cutting, rolling, buckling, breaking, brushing, and plucking.
